(19) United States
(12) Patent Application Publication
(10) Pub. No.: US 2021/0097475 A1
(43) Pub. Date: Apr. 1, 2021

(54) NETWORKED ACTIVITY MANAGEMENT WITH MEDIA COLLECTION AND SELECTABLE ACTIVITY INSERTION

(71) Applicant: IntelliSpeX, Inc., Edgewater, MD (US)

(72) Inventor: Blake D. Ratcliff, Edgewater, MD (US)

(21) Appl. No.: 17/027,781

(22) Filed: Sep. 22, 2020

Related U.S. Application Data
(60) Provisional application No. 62/908,453, filed on Sep. 30, 2019.

(51) Int. Cl. G06Q 10/06; H04L 29/08

(52) U.S. Cl. CPC G06Q 10/063114; G06F 3/0482; G06Q 10/06313; H04L 67/18

(57) ABSTRACT

Disclosed embodiments include systems, computer-implemented methods, and computer-readable media for managing information associated with one or more projects. In an illustrative embodiment, a server system is configured to receive an activity panel associated with an aspect of a project. The server system is further configured to communicate with systems used by individuals associated with the activity panel set to make the activity panel available to the individuals using the systems. The server system is also configured to receive an additional activity panel that is configured to be associable with a media file capturable by the system and insert the additional activity panel adjacent to a selected activity panel in the activity panel set. The server system is further configured to direct an address associated with the selected activity panel to identify the additional activity panel as a next activity panel in the series included in an updated activity panel set.

### PRIORITY CLAIM

The present application claims the priority and benefit of U.S. Provisional Patent Application Ser. No. 62/908,453 filed Sep. 30, 2019 and entitled “NETWORKED ACTIVITY MANAGEMENT WITH MEDIA COLLECTION AND SELECTABLE ACTIVITY INSERTION.”

### FIELD

The present disclosure relates to computer network-based activity management.

### BACKGROUND

The statements in this section merely provide background information related to the present disclosure and may not constitute prior art.

The statements in this section merely provide background information related to the present disclosure and may not constitute prior art.

It may be difficult to oversee a project staffed by multiple workers because of the difficulty in making sure that the workers each have the information they need for identified tasks. Managing multiple projects, particularly when those projects are located at different sites, further complicates the task.

For example, a construction company might be tasked with performing multiple construction or disaster recovery projects at a number of project sites. The sites might require involvement of electricians, plumbers, carpenters, painters, bricklayers, inspectors, construction laborers, and many other persons with particular expertise. As an example, at multiple locations electricians may be needed to identify wiring and parts needed, to perform installations, and to arrange for inspection of completed tasks. If an electrician must make one or more trips to a particular site just to determine parts or tools needed for the work, the electrician has that much less time to perform installation work. If he or she is called away by another electrician to help evaluate a problem at another site, more work time may be lost. Thus, there may be difficulty in managing the performance of tasks across multiple projects.

Just as managing workers across multiple locations may pose difficulties, even at a single location, managing multiple workers at a single location may present problems. Taking the same example of building or rebuilding a structure, an electrician may have to wait on carpenters or other framing contractors before installing wiring, receptacles, and switches or performing other electrical work. Electricians and carpenters may wish to communicate about the timing of work or to share information about particular facets where their tasks may intersect. The same may be true for drywall installers, heating and cooling contractors, plumbers, and numerous other workers. However, it is difficult to maintain a store of all the information where workers can access and share information about specific relevant tasks without important information becoming lost in the mass of information about the project as a whole.

### SUMMARY

Disclosed embodiments include apparatuses, systems, computer-implemented methods, and computer-readable media for managing information associated with one or more projects where users communicating over a network can selectably insert activity entries that may include associated media files.

In an illustrative embodiment, an apparatus includes a computing system configured to access at least one activity panel associated with at least one aspect of a project as part of a series of activity panels in an activity panel set. The computing system is further configured to communicate with a server system accessible by individuals associated with the activity panel set to make the activity panel available to the individuals. The computing system is also configured to create an additional activity panel configured to be associable with a media file capturable by the computing system and insert the additional activity panel adjacent to a selected activity panel in the activity panel set. The computing system is further configured to access an updated activity panel set in which an address field associated with the selected activity panel identifies the additional activity panel as a next activity panel in the series included in the updated activity panel set.

In another illustrative embodiment, a server system is configured to receive an activity panel associated with at least one aspect of a project as part of a series of activity panels in an activity panel set. The server system is further configured to communicate with computer systems used by individuals associated with the activity panel set to make the activity panel available to the individuals using the computing systems. The server system is also configured to receive an additional activity panel from one of the computing systems that is configured to be associable with a media file capturable by the computing system and insert the additional activity panel adjacent to a selected activity panel in the activity panel set. The server system is further configured to direct an address field associated with the selected activity panel to identify the additional activity panel as a next activity panel in the series included in an updated activity panel set.

In still another illustrative embodiment, a server system is configured to receive an activity panel associated with at least one aspect of a project as part of a series of activity panels in an activity panel set. The server system is further configured to communicate with computer systems used by individuals associated with the activity panel set to make the activity panel available to the individuals using the computing systems. The server system is also configured to receive an additional activity panel from one of the computing systems configured to be associable with a media file capturable by the computing system and insert the additional activity panel adjacent to a selected activity panel in the activity panel set. A user computing system is configured to access the activity panel and to create the additional activity panel. The user computing system is further configured to communicate with the server system accessible by individuals associated with the activity panel set to make the activity panel available to the individuals using the computing systems. The user computing system is also configured to access the updated activity panel set.

In yet another illustrative embodiment, a computer-implemented method includes accessing from a user computing system at least one activity panel associated with at least one aspect of a project as part of a series of activity panels in an activity panel set maintained at a server system. An additional activity panel configured to be associable with a media file capturable by the user computing system is created. The additional activity panel is inserted adjacent to a selected activity panel in the activity panel set. An updated activity panel set is accessed in which an address field associated with the selected activity panel identifies the additional activity panel as a next activity panel in the series included in the updated activity panel set.

In another illustrative embodiment, a computer-implemented method includes receiving at a server system an activity panel associated with at least one aspect of a project as part of a series of activity panels in an activity panel set. Over a network, the server system communicates with computer systems used by individuals associated with the activity panel set to make the activity panel available via the computer systems. An additional activity panel configured to be associable with a media file capturable by one of the computing systems is received. The additional activity panel is inserted adjacent a selected activity panel in the activity panel set. An address field associated with the selected activity panel is directed to identify the additional activity panel as a next activity panel in the series included in an updated activity panel set.

In still another illustrative embodiment, a non-transitory computer-readable medium stores therein computer-executable instructions to cause a user computing system to access from the user computing system at least one activity panel associated with at least one aspect of a project as part of a series of activity panels in an activity panel set maintained at a server system. Additional instructions cause the user computing system to create an additional activity panel configured to be associable with a media file capturable by the user computing system and insert the additional activity panel adjacent to a selected activity panel in the activity panel set. Further instructions cause the user computing system to access an updated activity panel set in which an address field associated with the selected activity panel identifies the additional activity panel as a next activity panel in the series included in the updated activity panel set.

In still another illustrative embodiment, a non-transitory computer-readable medium stores therein computer-executable instructions to cause a server computing system to receive at the server computing system an activity panel associated with at least one aspect of a project as part of a series of activity panels in an activity panel set. Additional instructions cause the server computing system to communicate over a network with computer systems used by individuals associated with the activity panel set to make the activity panel available via the computer systems. Further instructions cause the server computing system to receive an additional activity panel configured to be associable with a media file capturable by one of the computing systems. Other instructions cause the server computing system to insert the additional activity panel adjacent a selected activity panel in the activity panel set. Additional instructions cause the server computing system to direct an address field associated with the selected activity panel to identify the additional activity panel as a next activity panel in the series included in an updated activity panel set.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIG. 1 is a schematic view of a network environment in which project management data stored at a server is accessible by portable and nonportable computing devices;

FIG. 2 is a block diagram of a representative computing system that may represent a structure of a server and other portable and nonportable computing system of the network of FIG. 1;

FIG. 3 is a schematic view of activity panels grouped into activity panel sets for tracking activities that are accessible by selected individuals;

FIGS. 4A, 4B, and 5 are schematic views of activity panels grouped into activity panel sets allowing entry of additional activity panels at selectable locations;

FIGS. 6A-6P are schematic representations of media files that may be attached to activity panels;

FIGS. 7, 11, and 14 are schematic views of individuals involved in a project;

FIG. 8 is a schematic view of an individual creating an activity panel set;

FIG. 9 is a schematic view of the individual of FIG. 8 generating an activity panel set and identifying authorized participants;

FIGS. 10, 13, 18, 21 are schematic views of individuals receiving messages regarding an activity;

FIGS. 12, 15, 16, 17, 19, 20, 22, and 23 are schematic views of creating and inserting a new activity panel at a selected point within the activity panel set;

FIGS. 24 and 26 are schematic views of an activity panel set before and after a user moves an activity panel within the activity panel set;

FIGS. 25 and 27 are schematic views of records associated with the activity panels showing changing of pointers in response to the user moving the activity panel as shown in FIGS. 24 and 26;

FIGS. 28-29 are schematic views of a user replicating an activity panel to include the activity panel at two locations within an activity panel set in an offline mode;

FIGS. 30 and 31 are schematic views of records associated with the activity panels at times when the user replicates the activity panel in an offline mode in FIGS. 28-29 and subsequently resumes online mode;

FIG. 32 are schematic views of users selectively being provided with location information regarding other individuals associated with an activity panel set;

FIG. 33 are schematic views of users receiving messages regarding introduction of a new activity panel depending on attributes of the users and/or the activity panel;

FIG. 34 is a schematic view of an activity panel set including activity panels conveying evaluative and analytical information;

FIG. 35 is a schematic view of activity panels in an activity panel set selected for inclusion in another activity panel set or in a report;

FIGS. 36A and 36B are schematic views of a representative data structure for receiving and maintaining data records used in the activity panels;

FIG. 37 is a schematic view of a data structure for collecting other information generatable by various embodiments;

FIG. 38 is a flow diagram of an illustrative method of selectively inserting an additional activity panel from a user computer system; and

FIG. 39 is a flow diagram of an illustrative method of responding at a server system to a request to insert an activity panel adjacent to a selected activity panel.

### DETAILED DESCRIPTION

The following description is merely illustrative in nature and is not intended to limit the present disclosure, application, or uses. It will be noted that the first digit of three-digit reference numbers and the first two digits of four-digit reference numbers correspond to the first digit of one-digit figure numbers and the first two digits of two-digit figure numbers, respectively, in which the element first appears.

The following description explains, by way of illustration only and not of limitation, various embodiments of systems and methods for managing information associated with one or more projects where individuals can selectively engage and share information at selected locations in an ongoing thread in which information for a project is maintained.

Various disclosed embodiments can help address several issues regarding management of projects, including without limitation information sharing and management and resource management and optimization. For example, various disclosed embodiments can help to create an irrefutable record of project conditions, such as by capturing media files and associated the media files with timestamps and geolocation data (thereby demonstrating conditions and verifiable times and locations). As a further example, various embodiments can allow review of media files and communications between sites. As a result, such embodiments can help permit review of conditions with complete, context-specific, recorded information to support decision making regarding change orders, appropriateness of repairs and other measures, planning for continued project work, and other steps. Various embodiments can provide for selective insertion of comments or other information in the record, thereby helping to allow for information to be logged where it is relevant. Thus, the information collection and communication made possible by various embodiments allows users to interact as though each of them is present on site without investing in the time or expense in actually taking all such individuals to the site.

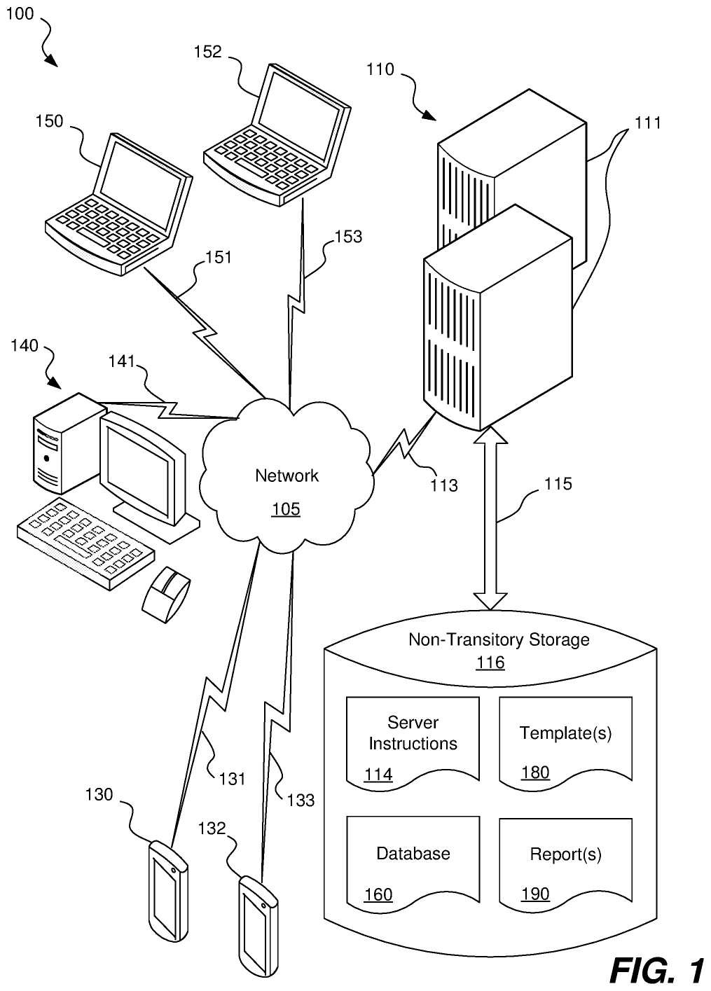

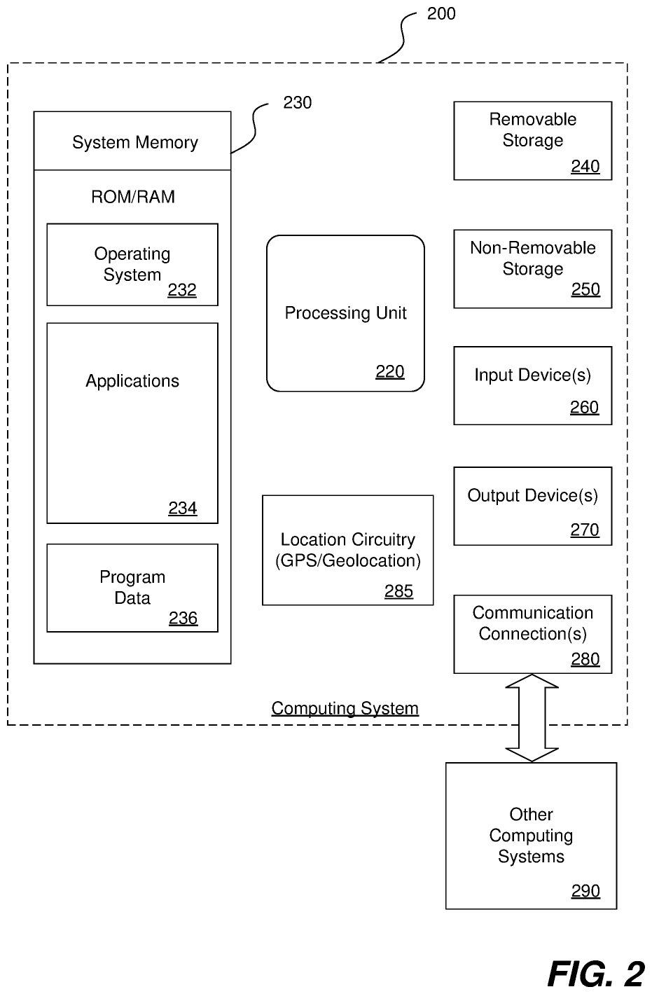

Referring to FIG. 1, in various embodiments a network environment 100 includes various nonportable and portable computing devices that share information via the network as described further below. Smartphones (or tablets) 130 and 132, a desktop computer 140, and laptop or notebook computers 150 and 152 access data maintained at a server system 110. (Although subsequent descriptions commonly refer to devices used by users at sites as “smartphones,” it will be appreciated that any portable device with a display and communications capabilities, such as tablets or tablet phones may be used in various embodiments.) The list of portable and nonportable computing systems 130, 132, 140, 150, and 152 are provided for example and illustration and is not intended to be limiting. The use of the designation “computing system,” as described further below, is not intended to suggest any particular type of computer or other device. The designation “computing system” is used to generally encompass any device capable of processing instructions and accessing the server system 110 to provide or retrieve data. The general architecture and structure of the various player computing systems 130, 132, 140, 150, and 152 is described below with reference to FIG. 2.

In various embodiments the server system 110 may include one or more server computing systems 111 arranged in a cluster or “server farm” arrangement to service users of the various computing systems 130, 132, 140, 150, and 152. The server computing systems 111 are coupled, possibly through a high-speed channel or bus 115, with non-transitory storage 116 that the server computing systems 111 share or that is duplicated for each of the server computing systems 111. The non-transitory storage 116 may include direct access hard disk devices, solid-state memory devices, or another storage technology. In various embodiments, the non-transitory storage 116 includes operating system software and other utilities used to operate the server computing systems 111 (not shown in FIG. 1) and may also include a database 160, templates 180, storage for reports 190, and server instructions 114 for operating and managing access to the database 160, templates 180, and reports 190, all of which are further described below.

In various embodiments the server system 110 is coupled to a network 105, which may include the Internet or another computer network, via a network connection 113 (such as a high-speed connection) to provide sufficient bandwidth to support multiple users accessing the server system 110 with minimal latency. The computing systems 130, 132, 140, 150, and 152 connect to the network 105 via communications links 131, 133, 141, 151, and 153, respectively. The communications links 131, 133, 141, 151, and 153 may include wireless data communications link such as provided by cellular-type communications network or a Wi-Fi network that enables communication with the network 105. Other means of wireless communications, such as Bluetooth communications or other means of wireless communication may be used. In addition, although not commonly used with handheld computing systems 130 and 132, the communications links 131, 133, 141, 151, and 153 also may include wired network connections, such as Ethernet connections (which, in the case of a handheld-computing systems 130 and 132 or another portable computing device such as laptop or notebook computing systems 150 and 152, may be provided through a docking station, not shown in FIG. 1). The communications links 131, 133, 141, 151, and 153 may be continuous or switchable links that provide continual access to the network 105 or selective, as-desired access to the network 105, respectively.

It will also be appreciated that the server system 110 and the network 105 may be operated by a third-party provider, such as a commercial web services provider. The various embodiments described do not depend on any particular type of hardware or ownership of the hardware used to support the networked system herein described.

It will be appreciated that many different types of computing systems may be used in the system 100 of FIG. 1. Referring additionally to FIG. 2 and given by way of illustration only and not of limitation, some form of an illustrative computing system 200 may be used for any of the computing systems 130, 132, 140, 150, and 152—as well as the server computing system 111. In such embodiments, the computing system 200 typically includes at least one processing unit 220 and a system memory 230. Depending on the exact configuration and type of computing device, the system memory 230 may be volatile (such as random access memory (“RAM”), non-volatile (such as read-only memory (“ROM”), flash memory, and the like) or some combination of volatile memory and non-volatile memory. The system memory 230 typically maintains an operating system 232, one or more applications 234, and program data 236. The operating system 232 may include any number of operating systems executable on desktop or portable devices including, but not limited to, Linux, Microsoft Windows®, Apple OS®, or Android®. The one or more applications 234 executed on a server computing system 111 may include the server instructions 114 for operating and managing access to the database 160, templates 180, and reports 190, as further described below.

The computing system 200 may also have additional features or functionality. For example, the computing system 200 may also include additional data storage devices (removable and/or non-removable) such as, for example, magnetic disks, optical disks, tape, or flash memory. Such additional storage is illustrated in FIG. 2 by removable storage 240 and non-removable storage 250. Computer storage media may include volatile and non-volatile, removable and non-removable media implemented in any method or technology for storage of information, such as computer-readable instructions, data structures, program modules or other data. The system memory 230, the removable storage 240, and the non-removable storage 250 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 200. Any such computer storage media may be part of the computing system 200.

The computing system 200 may also have input device(s) 260 such as a keyboard, mouse, pen, voice input device, touchscreen input device, etc. Output device(s) 270 such as a display, speakers, printer, short-range transceivers such as a Bluetooth transceiver, etc., may also be included. The computing system 200 also may include one or more communication connections 280 that allow the computing system 200 to communicate with other computing systems 290, such as over a wired or wireless network or via Bluetooth (a Bluetooth transceiver may be regarded as an input/output device and a communications connection). The one or more communication connections 280 are an example of communication media. Available forms of communication media typically carry computer-readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, RF, infrared and other wireless media. The term computer-readable media as used herein includes both storage media and communication media.

In further reference to FIG. 2, for individuals expected to travel to remote sites, the computing system 200 desirably includes location circuitry 285. In various embodiments, the location circuitry 285 includes circuitry including global positioning system (“GPS”) circuitry and/or geolocation circuitry. The location circuitry 285 can automatically discern its location based on relative positions to multiple GPS satellites and/or triangulation using cellular carrier network(s) and/or IEEE Standard 802.11 wireless (“WiFi”) networks (collectively referred to as “geolocation services”) to determine location based on multiple cellular communications facilities and/or multiple WiFi networks. The location circuitry 285, including GPS circuitry and/or geolocation circuitry, is frequently incorporated in smartphones and many other tablets or other portable devices. As described further below, location circuitry 285 may be used to automatically generate location data that is usable to report a location of an individual at a site, which then may be recorded. Periodic requests for location information sent to the smartphone may indicate whether the individual is within a specified distance of the site so that the individual can be logged as being present. This type of information may be useful in evaluating the individual's performance of his or her job, to determine payment, or for other reasons.

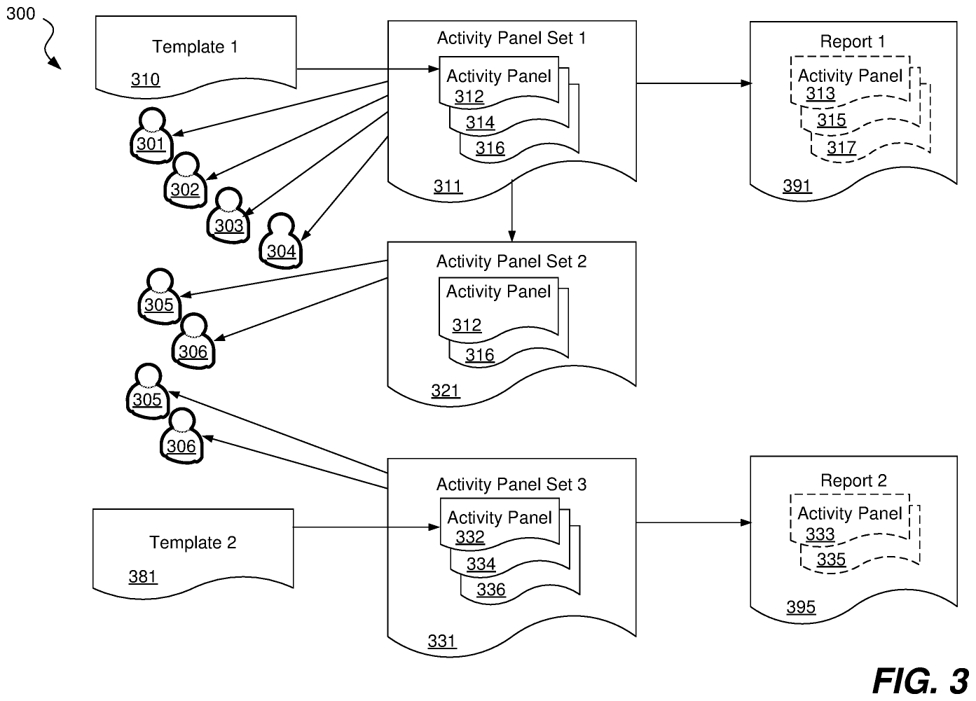

Referring additionally to FIG. 3, various embodiments include activity panels that may be created and selectively linked with other activity panels within activity panel sets in the system 300. The activity panels are analogous to data records that may be created and manipulated to store and manage data maintained within the system 300. A template 310 may be used to define parameters of the activity panels, such as activity panels 312, 314, 316, 332, 334, and 336 depicted in FIG. 3. The template 310 defines the type of information each activity panel may store, and different templates 310 may be used for different types of management environments or tasks. For example, one type of template 310 may be used for managing construction projects. It will be appreciated that another type of template 310 may be used for customer service ticket management, for managing software implementation projects, patient healthcare, educational projects, or any conceivable type of project. Various embodiments are suited to any type of project in which persons may need to access information about selected issues horizontally across multiple projects, or vertically among persons of different areas of expertise within a single project.

Continuing to refer to FIG. 3 and for the sake of a consistent illustrative example used in connection with FIGS. 3-23, it is assumed that the project involves a construction project. The project may span multiple job sites and, thus, involve managing individuals and other resources horizontally across multiple sites or sub-projects. The project also may involve management of professionals in different trades, such as plumbers, drywall contractors, painters, and others, aligned vertically to complete a single project, possibly among any number of projects. It will be appreciated, however, that this is just an example, and disclosed embodiments are not limited in any way to the example of a construction project. For example, and given by way of illustration only, it will be appreciated that various disclosed embodiments may be used in projects such as, without limitation, construction management, disaster recovery management, change management, healthcare management, educational management, manufacturing management, research management, and any other type of project.

In various embodiments a template 310 is selected to define a set of activity panels 312, 314, and 316 that are suited to managing construction projects. The template may specify content of the activity panels 312, 314, and 316, such as describing fields that designate who is able to access the activity panels 312, 314, and 316 or is authorized to create new activity panels in an activity panel set 311. The activity panel set 311 may be analogized to a folder containing the activity panels 312, 314, and 316 that constitute the pages in that folder, and thus contain information for a particular job. As will be appreciated, various embodiments store the activity panels 312, 314, and 316 in the activity panel set 311 and allow for users to insert additional pages or activity panels at desired locations within the folder represented by the activity panel set 311. In this way, users looking at one or more selected activity panels 312, 314, and 316 in the set will then see newly-inserted activity panels inserted adjacent to the activity panels 312, 314, and 316 to which each relates.

Continuing with the paper-in-folder analogy, new information relating to, for example, a page (activity panel) in the middle of the folder (activity panel set), will not be inserted at the front or the back of the folder (activity panel set) where it may be missed by one looking at a page (activity panel) in the middle of the folder (activity panel set). Instead, users may insert activity panels where the activity panels are desired to be placed to communicate further information about exiting activity panels.

The activity panels 312, 314, and 316 are used by individuals using computer systems 130, 132, 140, 150, and 152 (FIG. 1) and representations 313, 315, and 317 (shown in dashed lines) of activity panels 312, 314, and 316 may be collected in report form, such as a report 1 391. The representations 313, 315, and 317 may be optimally formatted for a printed or printable report, as opposed to the format of the activity panels 312, 314, or 316 which may be formatted to appear on the display of a smartphone, tablet, or other device. These reports 391 (which may be electronically stored in the report storage 190 in the non-transitory storage 116 associated with the server system 110) may be created to provide checkpoint information regarding the status of the project or capstone information for billing or project review at another point in the life of the project.

Access to the information in the activity panels 312, 314, and 316 may be provided to individuals 301-304 that may need or otherwise have use for the information represented in the activity panels 312, 314, and 316. Continuing with the example of a construction project, one individual may be a foreman or other manager; another may be a plumber; another may be a drywall contractor; and another may be a painter, all of whom may be associated with a site or project represented by activity panel set 1 311. In addition, various embodiments enable particular activity panels, such as activity panels 312 and 314 which may be relevant to other individuals 305 and 306, to also be simultaneously stored in activity panel set 2 321. Individuals 305 and 306 may not have a need to access all of the information in activity panel set 1 311, perhaps because of their skill sets. Thus, individuals 305 and 306 may only be given access to some of the activity panels 312 and 314.

At the same time, other activity panel sets, such as activity panel set 3 331, may include activity panels 332, 334, and 336, that were generated from template 2 381 for another type of project where different types of data are desired for inclusion in the activity panels. The activity panels 332, 334, and 336 may be logically stored in activity panel set 3 331, which may also be stored in the database 160 maintained in the non-transitory storage 116 of the server system 110 (FIG. 1). From activity panel set 3 331, a report 2 395 may be generated to include representations 333 and 335 which may represent, for example, activity panels 332 and 334, where a creator of report 2 395 may deem it unnecessary to include the content of activity panel 336. Various embodiments provide flexibility in the content of the activity panels and the reports as well as to whom access to the activity panels should be provided.

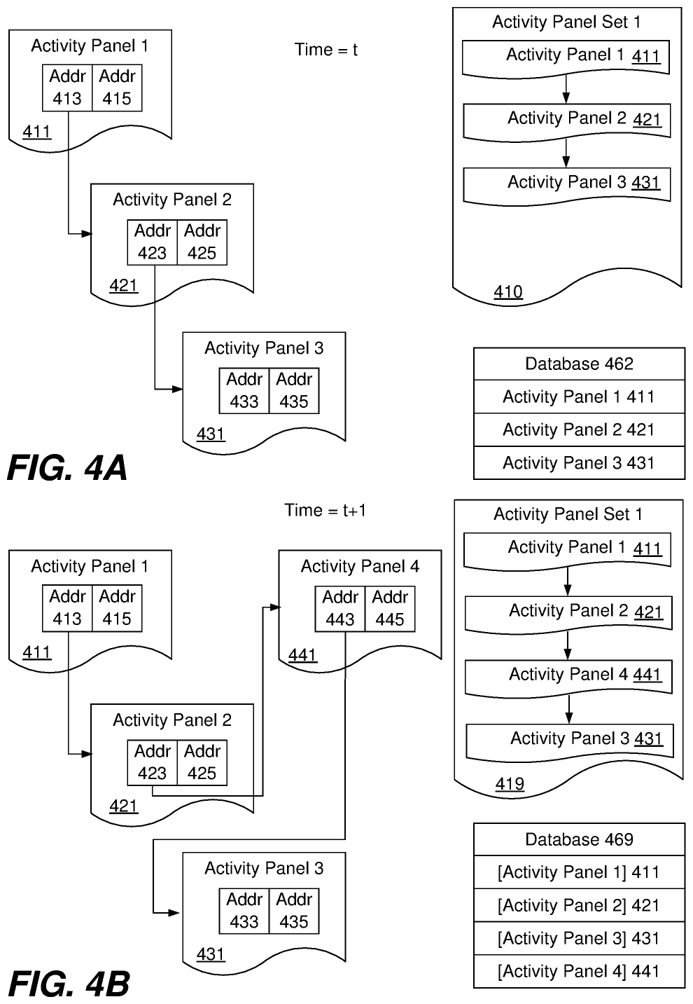

Referring additionally to FIGS. 4A and 4B, the logical arrangement of activity panels shows how activity panels may be inserted to allow information in a newly-created activity panel to be associated with an existing activity panel to which the newly-created activity panel's content may be relevant. Referring to FIG. 4A, the state of activity panel set 1 and the database are shown to correspond with the depicted listing of the activity panels. At time t, there are three activity panels, activity panel 1 411, activity panel 2 421, and activity panel 3 431. Each of the records of the activity panels 411, 421, and 431 includes one or more address fields or pointers. For example, the record for activity panel 1 411 includes pointers 413 and 415. These pointers are address fields into which the address of the next activity panel to be displayed should be listed. In the example of FIG. 4A, the address field or pointer 413 in activity panel 1 411 includes the address of—or “points to”—activity panel 2 421. The address field or pointer 423 in activity panel 2 includes the address of activity panel 3 431. Because activity panel 3 431 is the last in the sequence the address field or pointer 435 does not point to another activity panel. As a result, in the state at time t, activity panel set 1 410, the display of a smartphone or other device shows activity panels 411, 421, and 431.

It also will be appreciated that the records of the activity panels 411, 421, and 431, may be sequentially stored in a database 462 as they are created. The record of activity panel 1 411 is stored first, followed by the record of activity panel 2 413, and then followed by the record of activity panel 3 431.

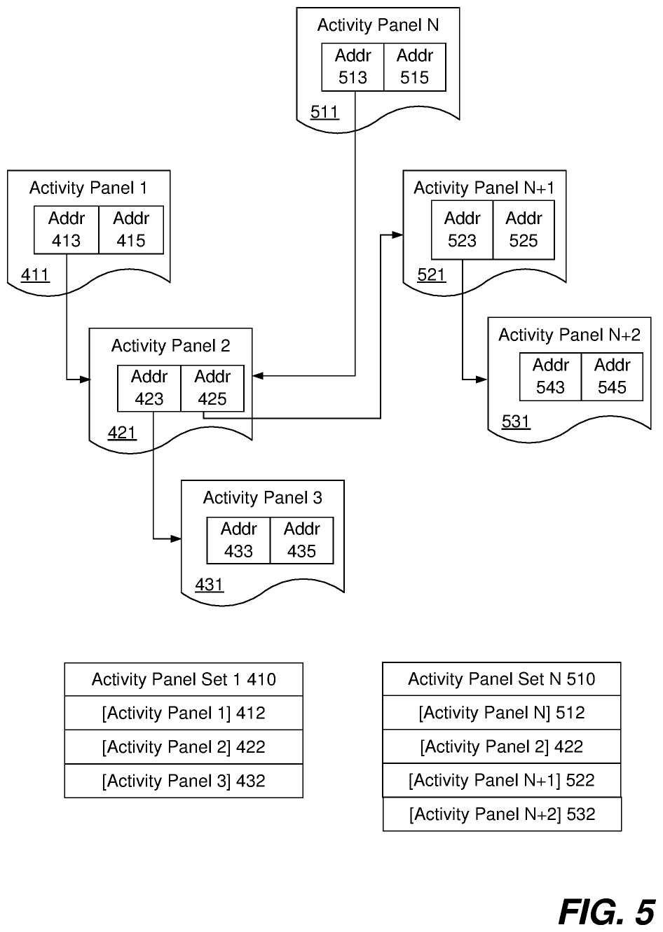

It will also be appreciated that, in various embodiments, including multiple address fields or “pointers” allows a record of an activity panel to be included in more than one list or records or activity panel sets. In this way, information (created by an individual) that may be relevant to more than one other activity panel may be included in an activity panel set for all projects to which the new activity panel pertains, as described further with reference to FIG. 5.

Referring to FIG. 4B, after activity panel 1 411, activity panel 2 421, and activity panel 3 431 have been created, an individual may want to insert a new activity panel, for example, between activity panel 2 421 and activity panel 3 431. Although it may seem a small thing to insert the new activity panel between activity panel 2 421 and activity panel 3 431 instead of inserting it after activity panel 3 431, it will be appreciated that, if the activity panel set includes dozens, hundreds, or thousands of activity panels, the effect of the intermediate insertion of the new activity panel would be more pronounced.

Continuing to refer to FIG. 4B, new activity panel 4 441 is created at time t+1, with its creator wanting it to be inserted adjacent to activity panel 2 421 to which it pertains. On the display of the computing device, this might be done by the user selecting a “create” command while viewing the representation 422 of activity panel 2 421. In terms of the data structure, however, the record for new activity panel 4 441 is created and the address field 423 of activity panel 2 421 is redirected to contain the address of—or point at—the record for activity panel 4 441. Then, the address field 443 of activity panel 4 441 is directed to point to previously-existing activity panel 3 431.

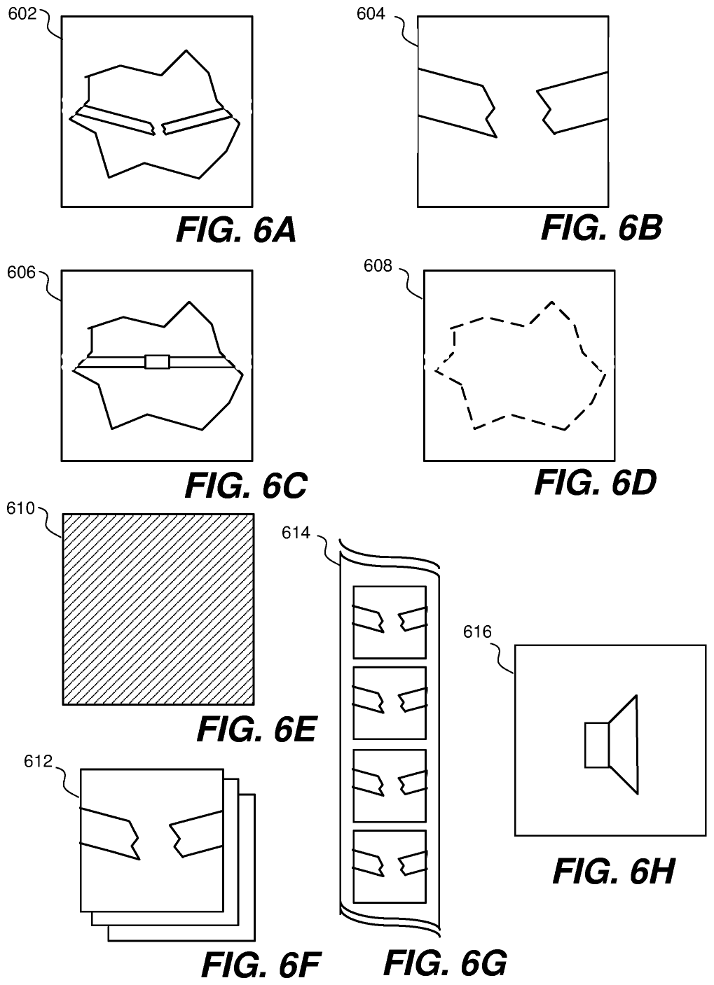

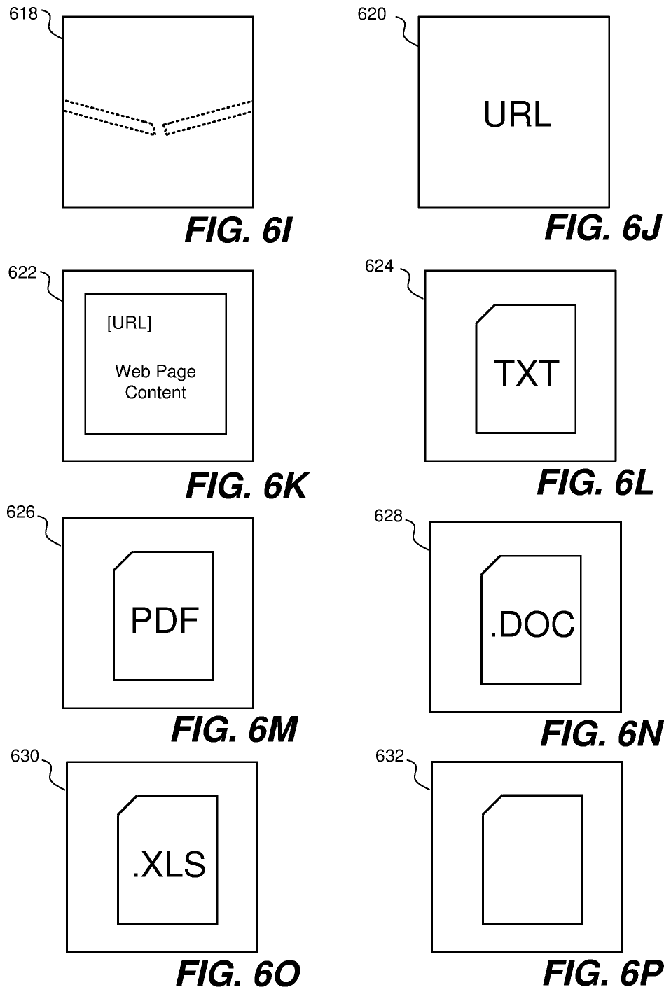

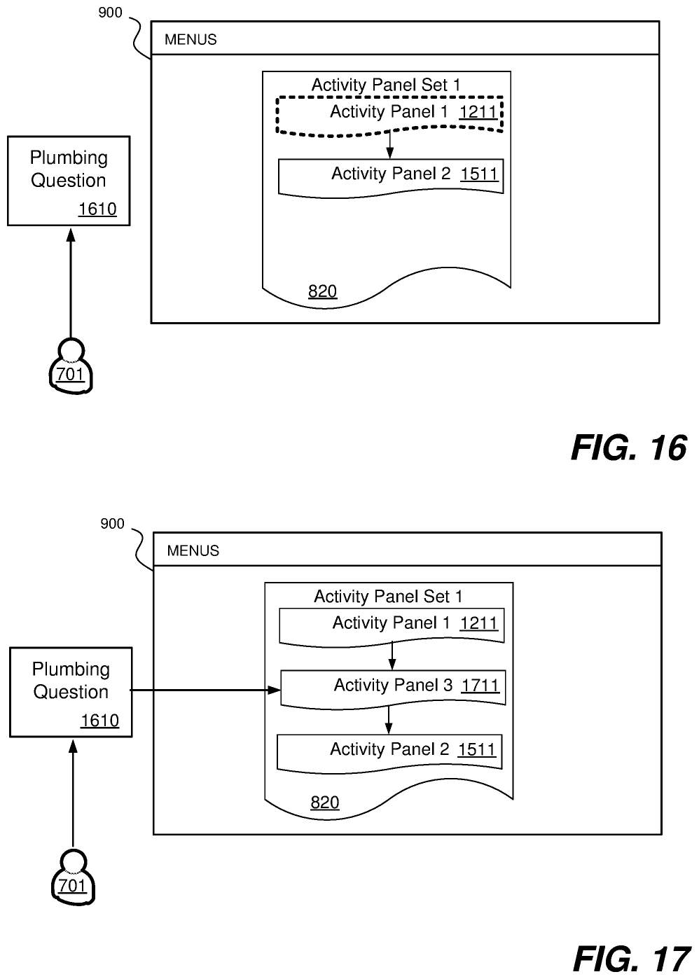

The effect of this process is shown in that, in updated activity panel set 1 419 at time t+1, activity panel 4 441 is displayed after activity panel 2 422 and before activity panel 3 432. Thus, the creator of activity panel 4 441 was able to insert the content he wished to add relating to activity panel 2 421 directly after activity panel 2 421 so that others accessing activity panel set 410 would see his newly-inserted content. At the same time, however, the state of the database 469 at time t+1, shows the record for newly-created activity panel 4 441 is stored at the end of the list (or wherever sequentially created records are stored). Thus, the user was able to insert content in the activity panel set where the user wants it to appear without the time and resources required to re-sort the database in which the records of the activity panels are stored. A practical example of the operation of the selective placement of new activity panels is described with reference to the example of FIGS. 6A through 23, with particular reference to FIGS. 16-23.

Referring additionally to FIG. 5, a benefit of including multiple address fields or pointers in the records for the activity panels is that an activity panel may be included in more than one activity panel set. This is beneficial if the content of the activity panel pertains to more than one activity panel set or its users and avoids the user having to create the new activity panel multiple times.

Continuing with reference to FIG. 5, the record for activity panel 2 421 is included in two different activity panel sets, including activity panel set 1 410 (as described with reference to FIGS. 4A and 4B), and activity panel set N 510. As in FIG. 4A, the address field 413 of the record of activity panel 1 411 points to the record of activity panel 2 421, and the address field 423 of activity panel 2 421 points to the record for activity panel 3 431. Thus, representations 412, 422, and 432 of activity panels 411, 421, and 431, respectively, appear in that order in representing activity panel set 1 410.

However, in FIG. 5, the address field 513 of activity panel N 511 also points to activity panel 2 421, and the second address field 425 of activity panel 2 421 points to activity panel N+1 521. The address field 523 of activity panel N+1 521 points to the record of activity panel N+2 541. As a result, activity panel set N 510 includes, in order, representations 512, 422, 522, and 532 of the records for activity panel N 511, activity panel 2 421, activity panel N+1 521, and activity panel N+2 531, respectively. Thus, the record for activity panel 2 421 may be included in two different activity panel sets and the representations thereof without duplicating the record for the activity panel set or re-sorting the database, as described with reference to FIGS. 4A and 4B. It will be appreciated, and described below with reference to FIG. 31, that an activity panel may also be duplicated by duplicating the activity panel and inserting each of the duplicate copies into one or more activity panel sets at different locations.

Referring additionally to FIGS. 6A-6P, different types of media may be associated with records of activity panels. According to various embodiments, photographs, sets of photographs, and video may be captured and associated with activity panels. Insertion of media files allows users to exchange information in much more detail than might be possible with only words. In addition, as further described below, by attaching media files, an individual who may happen to be present in a region of interest but who may not be qualified to meaningfully describe a particular type of problem, can use media to convey useful information to knowledgeable parties. As a result, someone who happens to be in the right place at a right time can send media files to potentially save a skilled individual the time and expense of making a trip to make an in-person assessment. Media types also include information that may be acquired from other sources, rather than recorded at a job site, as further described below.

Continuing with the illustrative example of a construction project, FIGS. 6A-6P concern media relating to a repair project that will be referenced in subsequent figures. The example includes a broken water pipe that has resulted in drywall damage. To effect repairs, the broken pipe must be fixed, the drywall patched or replaced, and the surface will have to be repainted. To facilitate the repair, if a plumber is not yet on site, it may be helpful for someone who is present to send a photograph, a close-up photograph, a series of photographs from one angle or multiple angles, and/or even a motion video to capture the extent of the damage. These media files also may be helpful to drywall contractors or painters to see what damage they will have to repair after the broken pipe is fixed.

Along those lines, subsequent workers or their managers might want verification of preceding repairs (e.g., a photograph showing that the plumbing has been repaired) before dispatching other workers to further the overall repair project. Photographs of the repaired pipe, the repaired drywall, and a completed paint job also may be desirable proof to provide to construction managers, the owner of the building, insurance companies, etc., to verify that the work has been done and to allow them assess the quality of the work. The information conveyed by the media may be helpful to numerous such individuals—without any of these individuals having to make a separate trip to inspect the site. Moreover, the media may be captured by anyone at the site of the repair, so persons knowledgeable in the relevant crafts need not be dispatched to undertake an inspection.

Referring to FIG. 6A, a photograph 602 of a broken pipe taken through a rupture in a wall or ceiling shows an extent of damage to be repaired. Thus, an individual not on site can determine that the repair will require plumbing, drywall, and painting work. Referring to FIG. 6B, a close-up photograph 604 of the broken pipe might be required or requested by a plumber to determine whether the pipe is so badly damaged that it may need to be replaced, or whether the pipe can be repaired with a fitting, a patch, or the like. Referring to FIG. 6C, a photograph 606 of the repaired pipe (showing that the pipe was patched and did not need to be replaced) may be used to release payment to the plumber in a suitable amount and to have verification that the site is ready for further repairs. Referring to FIG. 6D, a photograph 608 shows that the drywall has been patched, indicating that the drywall contractor did the contracted job and the site is ready for painting. Referring to FIG. 6E, a photograph 610 of the painted surface may serve as confirmation that the work is complete, that payment should be made, and/or to evaluate the quality and timeliness of the work.

As previously mentioned, however, in some situations, a simple still photograph may not provide enough detail to memorialize the situation or to provide needed information to persons who do not happen to be present. Accordingly, various embodiments allow for the capture of series of multiple still images, providing multiple views by pressing the shutter once and/or only creating one activity panel. Professionals often find that streams of 3 or more images taken in succession provide detail and verification of a situation that may not be clearly expressed in a single shot. Referring to FIG. 6F, a stream of still images 612 of the broken pipe of FIG. 6B may provide more detail to concerned workers. Similarly, a video taken from different distances and different angles may reveal detail that may not be discernible from a single still photograph. Accordingly, various embodiments provide for the attachment of motion video files. Referring to FIG. 6G, a motion video 614 of the broken pipe may provide helpful information to interest parties. Referring to FIG. 6H, an audio file 616 may include some narrative comments from one of the individuals involved in the project, a recording of a potentially troubling noise being made by one or more objects at a worksite, or other sound files of potential interest. Some of the illustrative media files of FIGS. 6A-6P are included in the foregoing example to further illustrate the operation and advantages of various embodiments.

Media files that may be associated with activity panels may also include any other digitally-stored media, whether that media may be captured by a portable computing device or be collected or downloaded by other processes. For example, referring to FIG. 61, a still image, one or more sequences of images, or a motion video of an x-ray, ultrasound, infrared, or other non-visible-light imaging scan 618 may be accessed and attached to an activity panel. Referring to FIG. 6J, a uniform resource locator (URL) 620 to a web site that may be of relevance may be attached to the activity panel. Referring to FIG. 6K, instead of attaching a URL, the content of a web page 622 may be downloaded and attached to an activity panel.

Various other documents also may be attached to activity panels as media files. Text, graphical data, numerical or cost data, or other information may be attached as media files. For example, referring to FIG. 6L, a text file 624 including a checklist, measurements, specifications, or other information may be attached as a media file. Referring to FIG. 6M, a transportable text, graphics, or image file, such as a PDF file 626 may be attached as a media file. Referring to FIG. 6N, a proprietary format text file 628, such as a Microsoft Word® file may be attached as a media file. Correspondingly, referring to FIG. 6O, a proprietary numerical or spreadsheet file 630, such as a Microsoft Excel® file may be attached as a media file. Referring to FIG. 6P, any other format of data file 632, whether in a proprietary format created in a CAD system, geographical information system (GIS) files, charts, graphs, or media in any format also be attached as a media file. Any digital files that incorporate information that is potentially relevant to the project may be captured and linked as media files in various embodiments.

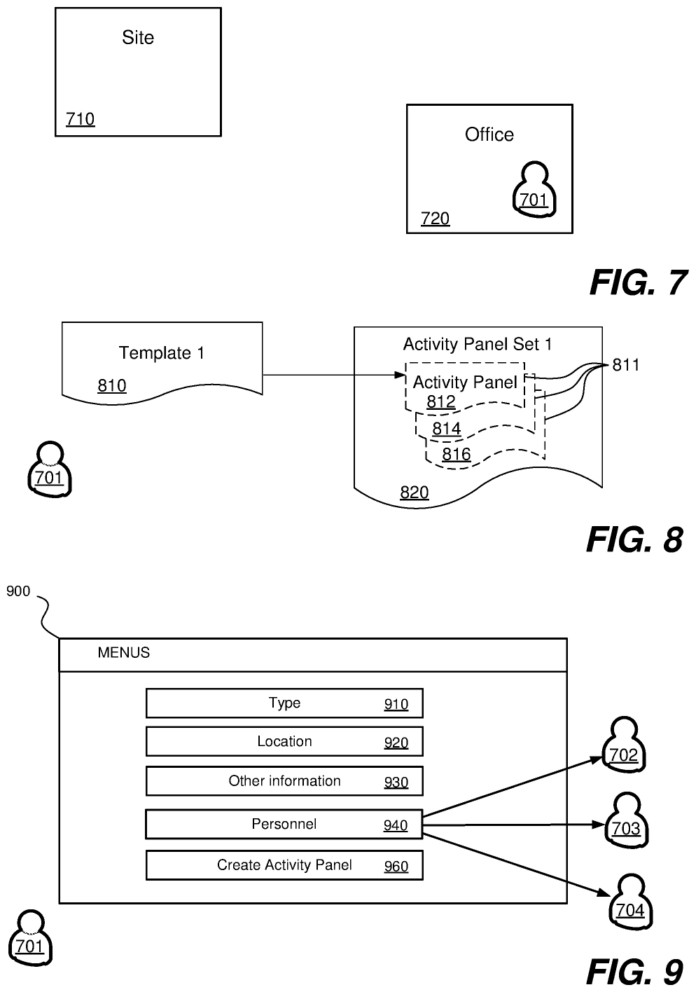

Referring additionally to FIGS. 7-31, a working example of the operation of a system using activity panels to communicate and log information is described. As previously mentioned, the example concerns a construction project in which a pipe has broken and there has been damage to the surrounding surface. The plumbing will have to be repaired, then the drywall of the surface will have to be repaired and painted.

Referring to FIG. 7, operation of various embodiments may be initiated by a manager 701 at an office 720 removed from a site 710 where damage has occurred. The manager 701 may receive a visit, telephone call, or email message from a homeowner, insurance company, or another involved party regarding the incident, and the manager may use an embodiment of the system to initiate repair operations.

Referring to FIG. 8, the manager 701 may consider the creation of an activity panel set to receive activity panels from persons engaged to effect the repairs. The manager 701 may consider that a desired format and content of the activity panels are embodied in template 1 810, and will use template 1 810 to define activity panel set 1 820 that will allow authorized users to create activity panels 811 including, for example, activity panels 812, 814, and 816 to collect and share information. The fact that the activity panels 812, 813, and 816 have not yet been created is indicated by the activity panels 812, 814, and 816 being represented in dashed letters.

Referring to FIG. 9, the manager 710 actually creates the activity panel set by accessing a computing system, which may include a nonportable or portable computer, such as a notebook or laptop computer, or even a tablet or smartphone, such as computing systems 130, 132, 140, 150 or 152 (FIG. 1). Via a computer display 900 (the rest of the computing system is not shown in FIG. 9), the manager 710 engages a software interface to the network-based system described with reference to FIG. 1. The software interface may be an application or app running on a local nonportable or portable computer, or the interface may be a browser that enables to the user to interact with screens generated by the server system 110 (FIG. 1). The user may select template 1 810 from a software menu by choosing a type 910 for activity panel set 1 820 that the manager envisioned.

The manager 710 may then populate the parameters of activity panel set 1 820 by, for example, specifying a location 920 of the site, other information 930 about the project, and personnel who will be included in and able to access activity panel set 1 820. Specifying a location 920 will enable the subsequently-identified personnel the address of the site, but, in various embodiments, can be used to create a geo-fence to track the presence of personnel at the site. By providing an address or other coordinates, personnel carrying or required to carry a smartphone with location circuitry 285 (FIG. 2) may be automatically registered as being present at the site. Also, the manager 710 may identify which personnel are attached to activity panel set 1 820. According to various embodiments, assigning personnel to activity panel set 1 820 determines who receives information pertaining to the project for which activity panel set 1 820 was established or who can generate activity panels to contribute information to activity panel set 1 820. In this case, the manager has associated individuals 702-704 with activity panel set 1 820 for the project. These individuals may be skilled in particular crafts for the project for which the manager 701 has used the system to create activity panel set 1 820.

Finally, after creating and populating fields for activity panel set 1 820, the manager 701 may choose an option 960 to create an activity panel. Creating an activity panel allows the manager 701 to specify a task that will be communicated to one of the individuals 702-704 whom the manager 701 has attached to the project.

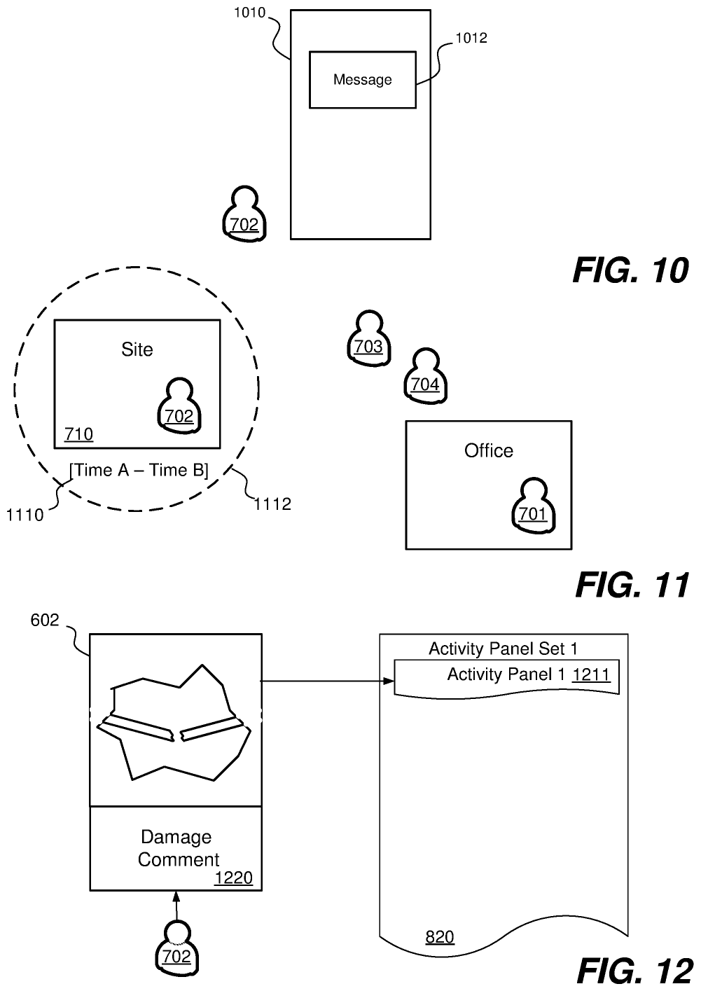

Referring to FIG. 10, upon the creation of the activity panel, on a display 1010 of a smartphone or other suitable computing device, individual 702 receives a message 1012. The message 1012 reports the nature of the event at the site 710. In the example of a broken pipe, the individual 702 may be a plumber who will visit the site 710 to assess the damage and/or to begin undertaking repairs.

Referring to FIG. 11, the individual 702 arrives at the site 710. As previously described, because the manager 701 entered the address or coordinates of the site in creating activity panel set 1 820, a geo-fence 1112 may be automatically or optionally created at the site. In various embodiments, the manager 701 or another user may be prompted to specify a radius around the specified address or coordinates that defines a limit of the geo-fence. In cases where there are multiple job sites in close proximity, the locus of the geo-fence 1112 may be desirably smaller so that one can differentiate the location of the individual relative to the various, nearby worksites. In setting up the activity panel set, the manager 701 also may be prompted for how frequently individuals' location is requested from the smartphone carried by the individual (from which the location is provided by the location circuitry 285, as described with reference to FIG. 2). By “pinging” the location circuitry 285 on the smartphone of the individual 702, a timestamp 1110 may be automatically generated to record how long the individual 702 was present at the site 710 for cost tracking, billing, staffing needs determinations, or other reasons.

By contrast, individuals 703 and 704 do not report to the site 710 and are not within the geo-fence 1112. Thus, while they may have also received messages on their smartphones (not shown in FIG. 11), their positions are not reported as being at the site 710. However, it may be recorded that the individuals are not at the site 710 for tracking purposes. According to various embodiments, individuals may be given the option to enable or disable their smartphones for geo-fence tracking. It may be up to the manager 701 and the other individuals 702-704 assigned to the site to what extent the individuals enable their smartphones 702-704 for geo-fence tracking.

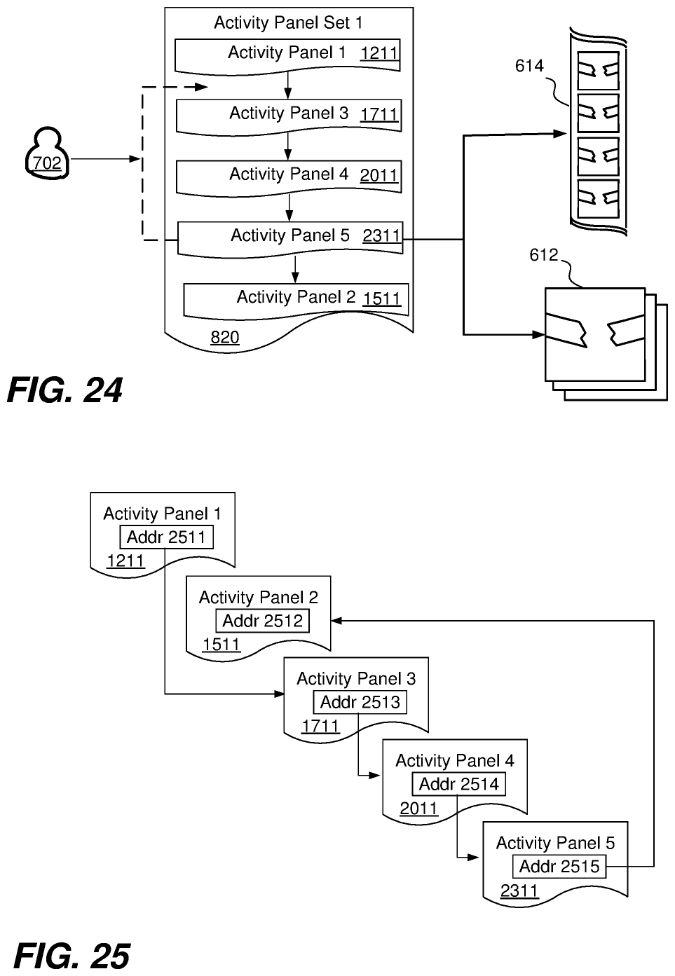

Referring to FIG. 12, individual 702 generates activity panel 1 1211 (which may be responsive to an activity panel generated by the manager 701 as described with reference to FIG. 9, but is not shown in FIG. 12 or subsequent figures). On viewing the aforementioned broken water pipe, the individual 702 takes photograph 602 of the broken pipe and the damaged wall. The photograph 602 is attached to activity report 1 1211, either by storing the photograph 602 in activity panel 1 1211 or by storing the photograph at another location and including a pointer to the photograph 602, as further described with reference to FIG. 24. The individual 702 also may add a comment 1220 about the damage to be included in activity panel 1 1211. The photograph 602 and the comment 1220 are now part of activity panel 1 1211 and, thus, are part of activity panel set 1 820. The information is now available to all individuals 701-704 to whom the manager 701 assigned access to activity panel set 1 820, as previously described with reference to FIG. 9.

It will be appreciated that the individual 702 may have no special skills relating to plumbing, drywall, painting, or other skills. The individual 702 may be used as a scout to evaluate projects at given sites or may simply have been the person closest to the site 710 regardless of his or her skill set. Because the individual 702 is able to collect and share media attached to activity panel 1 1211, the media (photograph 610 and comment 1220) may be used to decide if further media capture is desired or if a particularly skilled individual should be dispatched to evaluate the site 710.

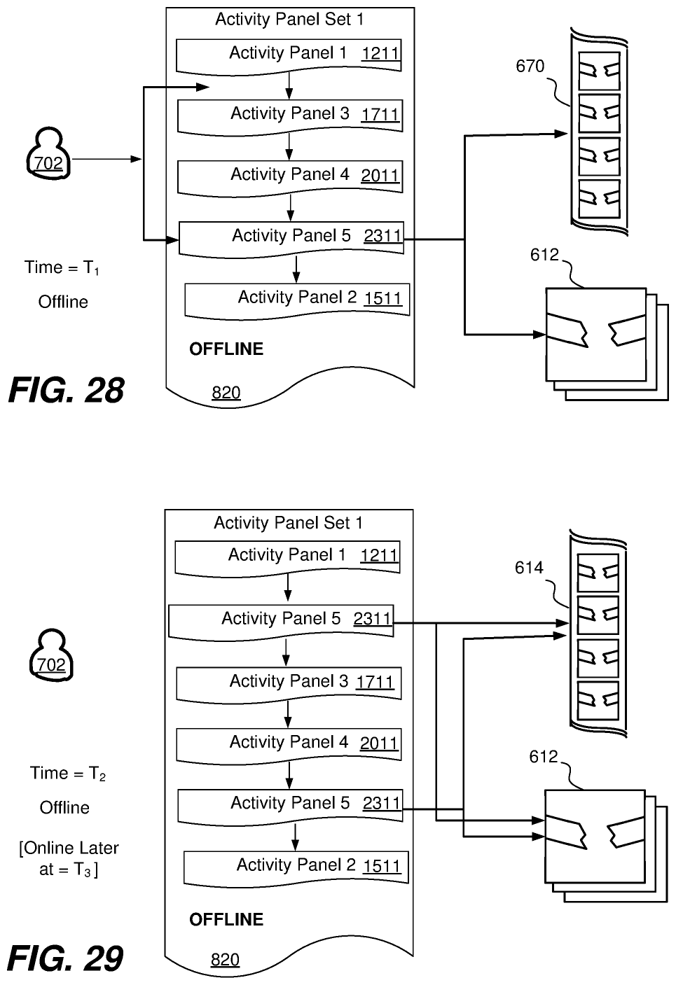

According to various embodiments, if the individual has no access to the network 105 (FIG. 1) when at the site or desires not to be connected to the network 105 while at the site 710, a user may make changes to an activity panel set, such as activity panel set 1 820. Once the user is back online with the network 105, the changes will be applied to the activity panel set. While offline, a user may add activity panels, replicate activity panels, or make other changes, as described below with reference to FIGS. 28-31.

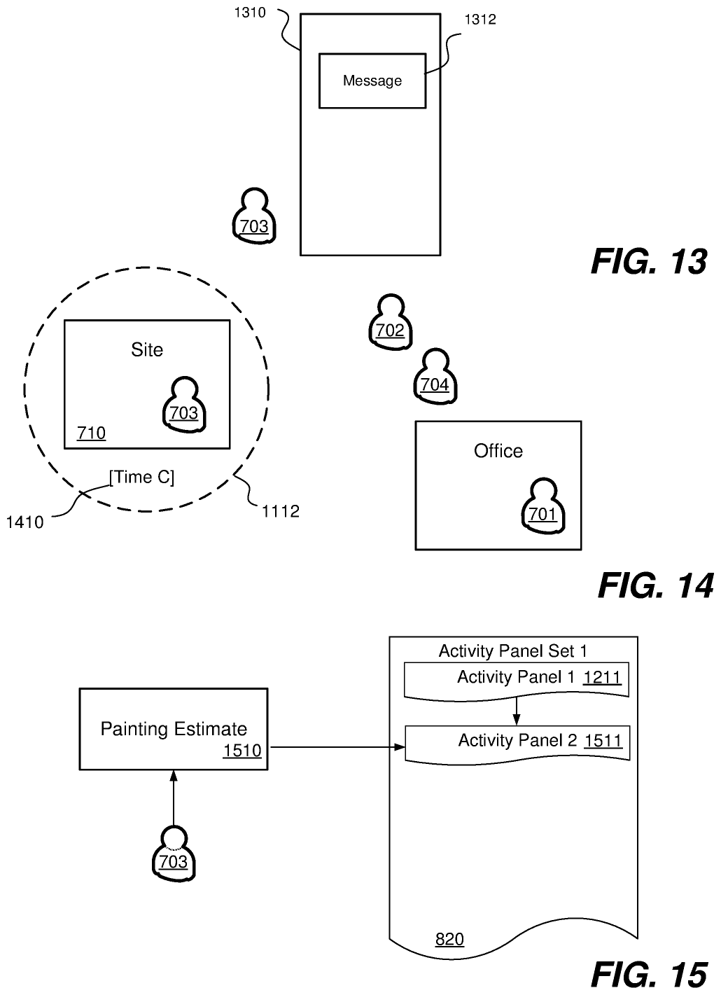

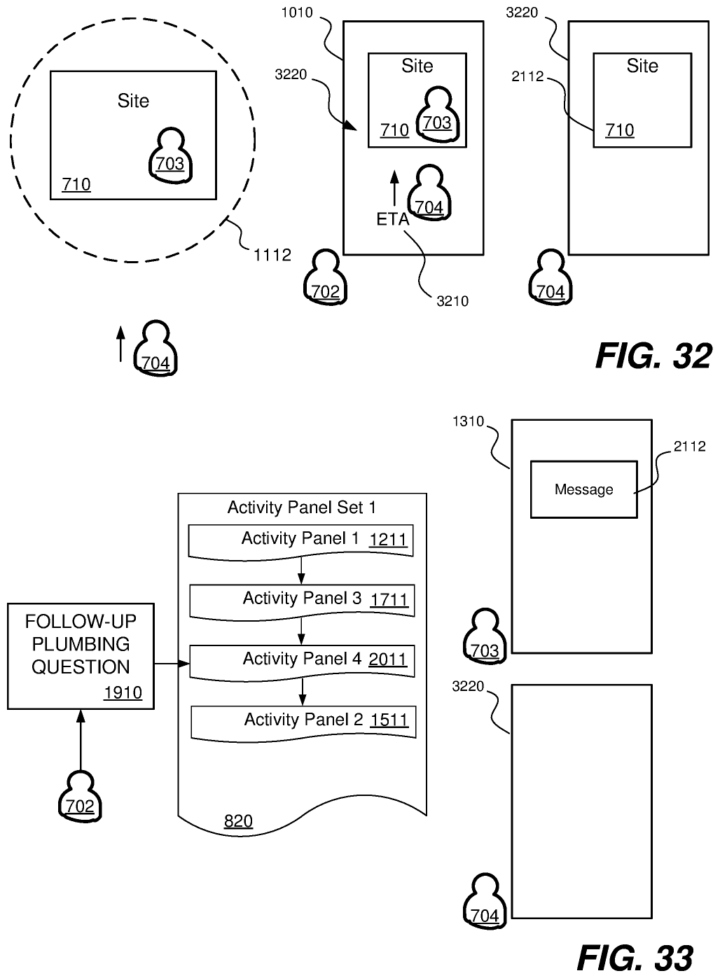

Referring to FIGS. 13-15, similar steps are repeated for a next assigned person, individual 703, when he or she receives a message and visits the site 710. Referring to FIG. 13, the individual 703 receives a message 1312 on the display of smartphone 1310 or another computing device. The message 1312 may be generated because the individual 703 is associated with activity panel set 1 820 and, thus, will receive a message 1312 as notification of any new activity panels. Alternatively, users associated with activity panel set 1 820 may have the option of having only selected or specified individuals receive a message notifying them when a user creates a new activity panel, or users may select to only receive messages indicating insertion of or changes to certain types of activity panels, as described below with reference to FIGS. 32 and 33

Referring to FIG. 14, in response to the message 1312, the individual 703 travels to the site 710. While the individual 703 is present at the site, the geo-fence 1112 logs presence of the individual 703 with a timestamp 1410. Individuals 702 and 704 are not present at the site, so their presence is not logged by the geo-fence 1112 (or individuals 702 and 704 are logged as not being present within the geo-fence 1112).

Referring to FIG. 15, the individual 703 does not capture any further media but generates a new activity panel 2 1511 to log a comment regarding a painting estimate 1510. In various embodiments, as a default and unless the user specifies a different result, new activity panels are added to the end of the list of activity panels in the activity panel set. Thus, activity panel 2 1511 is added to activity panel set 1 820 following the previously-created activity panel, activity panel 1 1211 created by user 702 as described with reference to FIG. 12.

Referring to FIG. 16, upon reviewing the information provided in activity panel 1 1211, the manager 701 decides that more information is needed about the plumbing situation, and the managers devise a plumbing question 1610. The manager 701 does not want the plumbing question 1610 to be lost in the shuffle of activity panels in activity panel set 1 820 and wants the plumbing question to be added to activity panel set 1 820 immediately following activity panel 1 1211 (that provided the initial information about the broken pipe). To specify a location for insertion of an activity panel, in various embodiments the user selects the activity panel that he or she wishes the newly-created activity panel to follow. Thus, the user 701 selects activity panel 1 1211 (represented by the bold dotted line around activity panel 1 1211 in FIG. 16).

Referring to FIG. 17, the manager 701 creates activity panel 3 1711 to pose the plumbing question 1610. Because activity panel 1 1211 was selected before creating activity panel 3 1711, activity panel 3 1711 is inserted immediately following activity panel 1 1211 that previously described the plumbing problem. Thus, the plumbing issues are presented together in activity panel set 1 820 where those interested in that issue will see both pertinent activity panels 1211 and 1711. Activity panel 2 1511 is then moved after activity panel 3 1711 in activity panel set 1 820. As previously described with reference to FIGS. 4A and 4B, in various embodiments the sequencing of the activity panels is effected with pointers and not by re-sorting the database of activity panels. The manipulation of pointers is also used to resequence or duplicate activity panels, as further described below. It will be appreciated that activity panel sequencing supported by the pointers does not interfere with the use of typical database management features, such as filtering, sorting, or other database functions that may be performed on a database and the records stored therein.

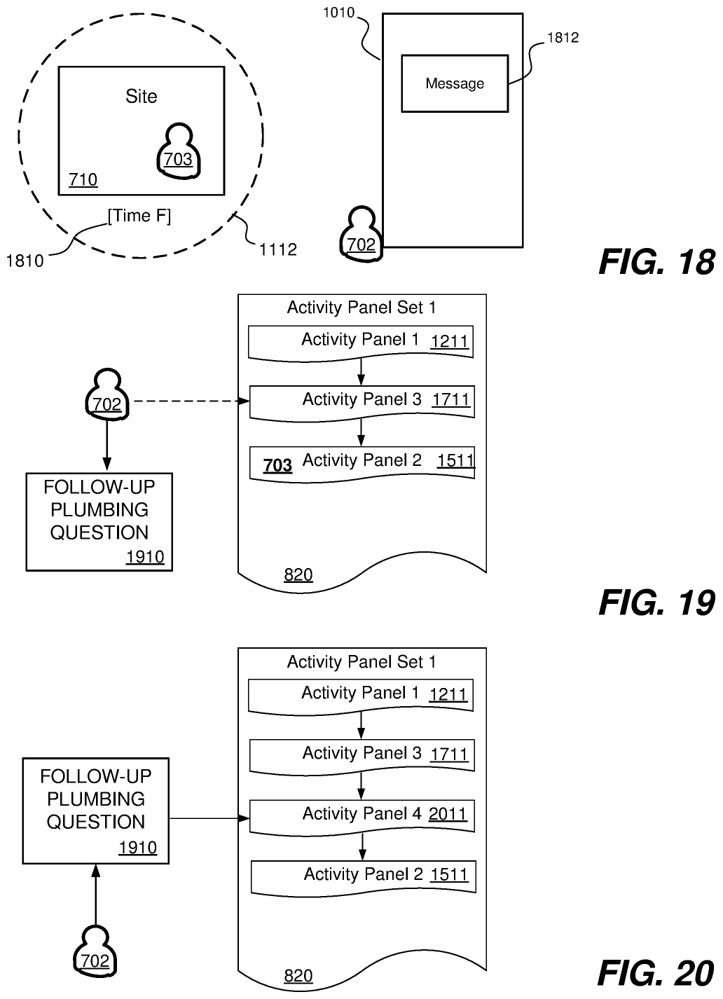

Referring to FIGS. 18-20, some individuals can take advantage of other individuals' presence at the site 710 to get information even if they themselves are not at the site 710 and the person who is at the site may not be skilled in the relevant craft. Referring to FIG. 18, while individual 703 is still at the site 710 (and individual 710's presence is again logged with timestamp 1810 as being within the geo-fence 1712), individual 702 sees message 1812 on the display 1010 of his or her smartphone. Opening the message, the individual 702 sees the plumbing question 1610 posed by the manager 701 in activity panel 3 1711, which motivates the individual 702 to think of a follow-up plumbing question 1910. Referring to FIG. 20, rather than visit the site him- or herself, the individual 702 creates another activity panel—activity panel 4 2011—to post the follow-up plumbing question 1910. Activity panel 4 2011 is included in activity panel set 1 820 following activity panel 3 1711 (which included the last plumbing question). As previously described, the individual 702 may have selected activity panel 3 1711 before creating a new activity panel. Thus, the newly-created activity panel (that is, activity panel 4 2011) would immediately follow activity panel 3 1711.

In various embodiments, the system may identify when another individual associated with an activity panel is present on-site (as indicated, for example, by individual 703's identifier being highlighted in activity panel set 1 820). Having this information may be used by the user to decide whether to visit the site or to post another activity panel to seek information without traveling to the site. The availability of information as to the location of various users may also be used to identify when personnel are on site, are approaching a site, or may be departing a site. Such information may be used to predict estimated time of arrival and whether the projected time adheres to a stated schedule. This information may be used to determine when these individuals are able to perform work, collect quality control information, provide quality assurance feedback, or to otherwise provide or receive guidance on site. The location tracking of personnel is further described below with reference to FIG. 32.

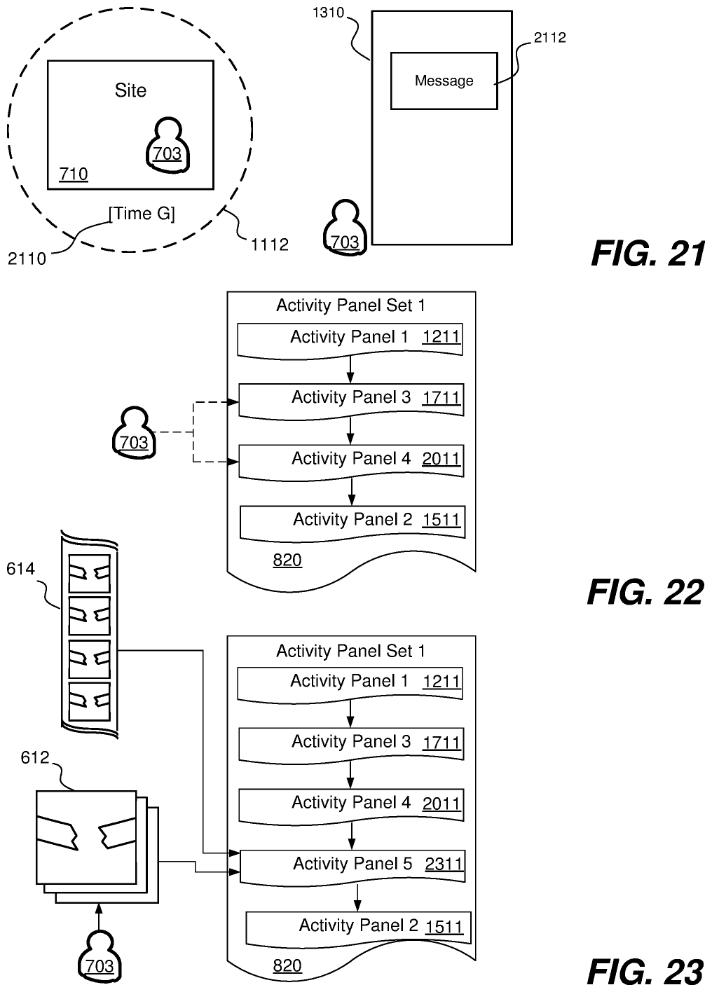

Referring to FIGS. 21-23, individual 703 (who is still present at the site 710 with a timestamp 2110 logging his or her presence within the geo-fence 1112) sees the message 2112 on the display 1310 of his or her smartphone, thereby alerting individual 703 to the arrival of a new activity panel. Referring to FIG. 22, upon viewing activity panel 3 1711 and activity panel 4 2011, the individual 703 reviews the further plumbing questions posted. Referring to FIG. 23, in an attempt to resolve the questions, individual 703 captures a sequence of photographs 612 and motion video 614 of the broken pipe, as described with reference to FIGS. 6F and 6G. The captured media 612 and 614 are added to activity panel 5 2311, which individual 703 inserts following activity panel 3 1711 and activity panel 4 2011 that posed the follow-up questions that motivated collection of the media to resolve the questions.

The creation and selective insertion of activity panels may continue to populate activity panel sets with activity panels that collect all the desired information. It will be appreciated that, the more activity panels that are created, the more beneficial it will be to insert an activity panel in response to a previous activity panel right after that activity panel (rather than dozens or hundreds of panels later).

Referring to FIGS. 24-27, users also may move activity panels as desired. For example, if an issue that a user believes is important has been obscured by the insertion of intervening or additional activity panels, a user can move the activity panel so that it is higher or lower in a sequence of activity panels and/or is presented in the list close to another activity panel that concerns a related topic. Referring to FIG. 24, for example, the user 702 may wish to move activity panel 5 2311 (and its associated media files 612 and 614 to be between activity panel 1 1211 and activity panel 3 1711. The user 702 may believe, for example, that other users should see activity panel 5 2311 immediately after reading activity panel 1 1211 or before reading activity panel 3 1711. Referring to FIG. 25, and with reference to FIG. 23, it will be recalled that activity panel 5 2311 was the most recently created activity panel, and the user 703 that originally created activity panel 5 2311 originally wanted activity panel 5 2311 to appear after activity panel 4 2011 and before activity panel 2 1511. As a result, and as shown in FIG. 25, when activity panel 5 2311 was created, the address field 2514 of activity panel 4 2011 was set to point to activity panel 5 2311, and the address field 2515 of activity panel 5 2311 was set to point to activity panel 2 1511.

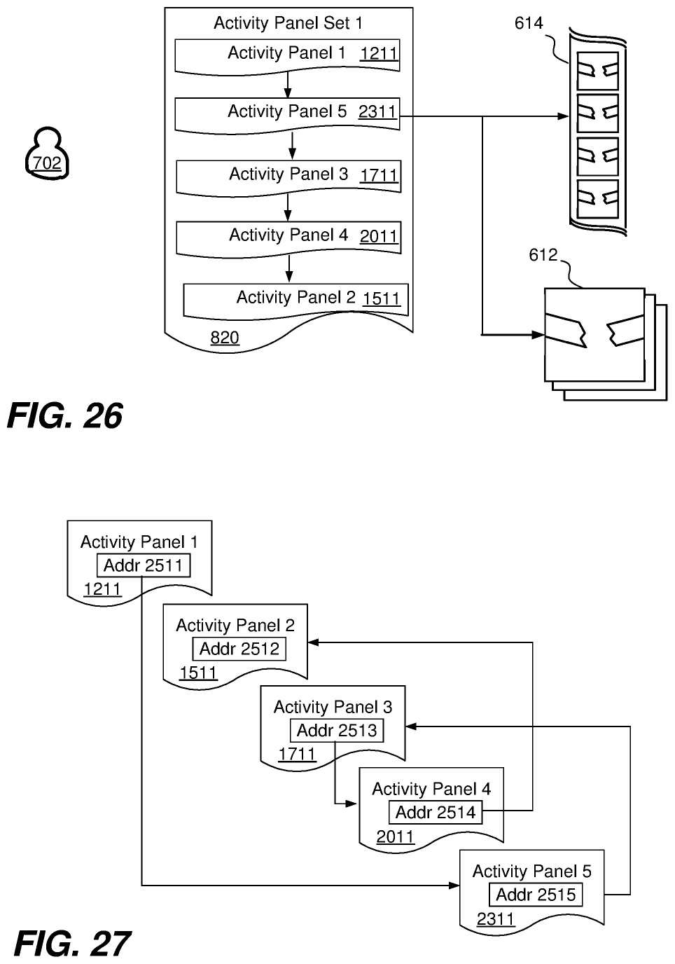

Referring to FIG. 26, the user has moved activity panel 5 2311 (and its associated media files 612 and 614) between activity panel 1 1211 and activity panel 3 1711 within activity panel set 1 820. As a result, referring to FIG. 27, the address field 2511 of activity panel 1 is set to point to activity panel 5 2311 so that activity panel 5 2311 will be the next activity panel after activity panel 1 1211. Also, the address field 2515 of activity panel 5 2311 is set to point to activity panel 3 1711 so that activity panel 3 1711 will be the next activity panel in activity panel set 1 820 after activity panel 5 2311. The address field 2513 of activity panel 3 1711 does not have to be changed because the address field 2513 of activity panel 3 1711 already points to activity panel 4 2011, which continues to be the next activity panel in activity panel set 1 820. However, because activity panel 5 2311 has been moved from after activity panel 4 2011 and activity panel 2 1511 now follows activity panel 4 2011 in activity panel set 1 820, the address field 2513 of activity panel 4 2011 is now set to point to activity panel 2 1511.

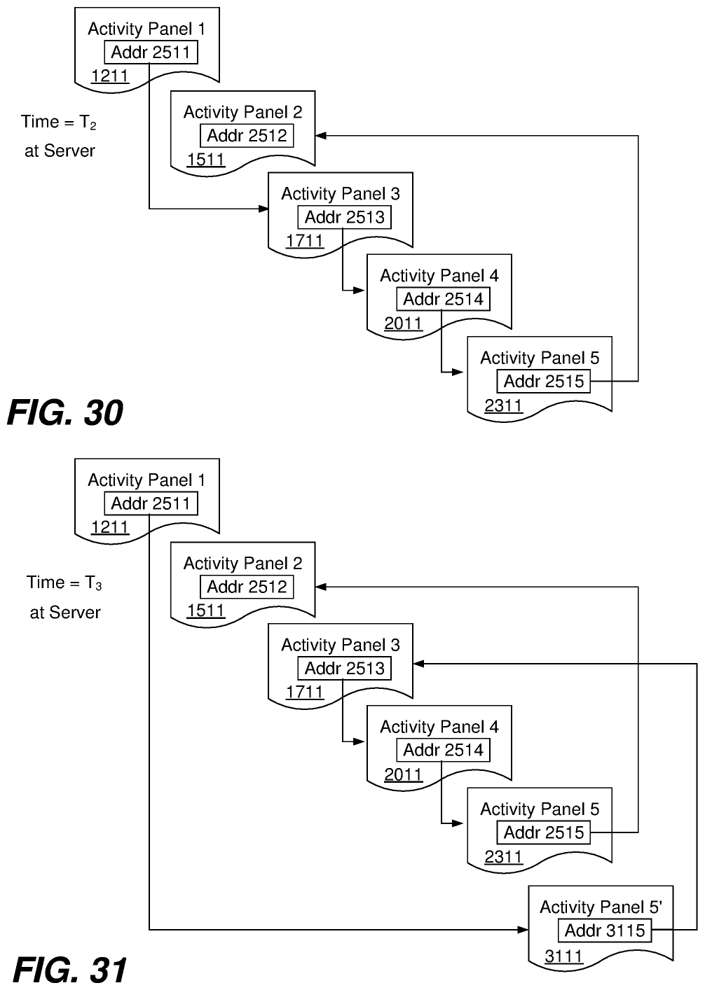

In addition to adding or moving activity panels, as described with reference to FIGS. 28-31, a user may wish to duplicate activity panels in an activity panel set. It will be appreciated that a user may wish to duplicate an activity panel because that activity panel may include information that is relevant to multiple different aspects of the activity panel set. As a result, a user may want an activity panel to appear adjacent to multiple other activity panels so that relevant information may be presented in various locations in an activity panel set. For example, an activity panel including details about details of a plumbing repair may be important to a plumber having to secure parts to make the repair and the need to make that repair may inform carpenters or drywall contractors of the need to plan their work to avoid that part of the job until the repair is made. As described below with reference to FIGS. 30-31, duplicating activity panels will necessitate changing to which activity panels various address fields or pointers are directed, as just described with reference to moving an activity panel as described with reference to FIGS. 24-27, as will be described with reference to FIGS. 30 and 31.

As also previously mentioned, various embodiments allow users to modify activity panel sets when they are offline and then apply the changes to the activity panel set for other users when those users are once again online. Thus, in FIGS. 28-31, a user duplicates an activity panel within an activity panel set while offline, then that change is applied to the activity panel set to the activity panel set for all the users when the user who changed the activity panel set is once again online. Although the process of duplicating an activity panel set is expressly shown as an offline task, it will be appreciated that adding or moving activity panels also may be performed offline. Correspondingly, duplicating activity panels may be performed while online, not just when a user is offline as shown in the example of FIGS. 28-31.

Referring to FIG. 28, at a time T₁, the user 702 is offline. In the example of FIGS. 28 and 29, instead of moving the activity panel 5 2311, the user 702 chooses to duplicate activity panel 5 2311. Instead of appearing only between activity panel 4 2011 and activity panel 2 1511, as shown in FIG. 28 at time T₂, while the user is still offline, the user 702 duplicates activity panel 5 2311 so that it appears both between activity panel 1 1211 and activity panel 3 1711 and between activity panel 4 2011 and activity panel 2 1511. The pointers to the associated media files 612 and 614 also are duplicated so that users will be able to access the media files 612 and 614 from both locations of activity panel 5 2311. It will be appreciated that duplicating activity panel 5 2311 does not necessitate duplicating the actual media files 612 and 614. Both locations of activity panel 5 2311 can point to the same copy of the media files 612 and 614 to permit users to access the media files 612 and 614 from either instance of activity panel 5 2311.

Referring to FIG. 30, at the server at time T₂, while the user 702 is offline, the linked list of activity panels at the server shows a sequence where, as before activity panel 5 2311 was duplicated, the address field of activity panel 1 2511 was set to point at activity panel 3 1511. In turn, the address field 2513 of activity panel 3 1711 was set to point at activity panel 4 2011. The address field 2514 of activity panel 4 2011 was set to point at activity panel 5 2311. The address field 2515 of activity panel 5 was set to point at activity panel 2 1511. In other words, because the user 702 is offline at T₂ when he duplicated activity panel 5 2311 and changed the sequence of activity panels in activity panel set 1 820, at the server at time T₂, the linked list of activity panels maintains the status of activity panel 1 820 before the duplication of activity panel 5 2311.

Referring to FIG. 30, at time T₃ when the user 702 is back online with the server, the changes the user 702 made to activity panel 1 820 are applied by creating a duplicate for activity panel 5 2311 with activity panel 5′ 3111 and changing the address fields or pointers for some of the activity panels in activity panel set 1 820. The address field 2511 if activity panel 1 1211 is set to point to the new duplicate activity panel 5′ 3111. The address field 3115 of activity panel 5′ 3111 is set to point to activity panel 3 1711. The address field 2513 of activity panel 3 1711 continues to point to activity panel 4 2011. Also, because activity panel 5 2311 was duplicated (and not moved, as in the example of FIGS. 24-27), the address field 2514 of activity panel 4 2011 continues to point to (the original) activity panel 5 2311. The address field 2515 of activity panel 5 2311 continues to point to activity panel 2 2512. With those changes made at the server, all users with access to activity panel set 1 820 will now see the updated sequence resulting from the changes previously made offline by user 702. The application of changes made by a user while offline may occur automatically when the user is back online or the user may manually initiate an update after he is back online. System setting may allow the user to decide whether offline updates are automatically applied when the user is back online or if manual update initiation is desired.

As previously mentioned, users may be given access to other users' locations to be able to determine if the other users are at a job site, on their way to a job site, etc. Referring to FIG. 32, user 703 is at the site 710 and user 704 is traveling to the site 710. By accessing the display 1010 of his or her smartphone, user 702 can see that user 703 is at site 710 and user 704 is en route to the site 710. The display 1010 also may present an ETA 3210 for the arrival of user 704 at the site 710, or a time or distance to be traveled by user 704 before reaching the site 710. The user 702 may have full access to the location of all of the other users during working hours, the user 702 may have been able to select access to specific other users, or those other users may have enabled user 702 to access their locations. Settings screens on applications executing on the users' devices or at the server may be used to set which users have access to each other's locations and during what hours, and may enable users to selectively enable or disable the location access. By contrast, for example, the user 704 may not have access to location data for the user 703. Thus, the display 3220 of the user 704 does not show the user 703 at the site 710 even when the user 703 is present at the site 710. The user 703 may not have elected to give location access to the user 704 or the user 704 may not have elected to receive location access for the user 703.

As previously described, it may be helpful to users to know if other users are at a particular location to help them gather information at the site where he or she may be present. As also previously described, it may be useful for personnel management to be able to receive location information to determine or verify locations of users for timekeeping, to ensure that personnel are on site for quality assurance, or for other reasons.

Similarly, as location information may be provided to some users for other users, message indicators for the introduction or change of activity panels may be selective. Referring to FIG. 33, for example, when the user 702 introduces the activity panel 4 2011 regarding a follow-up plumbing question (as previously described with reference to FIGS. 20 and 21), the user 703 may receive a notification message 2112 on the display 1310 of his or her device. On the other hand, the user 704 may not receive a notification message on the display 3220 of his or her device. Options may be provided to allow users to suppress messages so that they only receive the information when they choose to view the activity panel set. Alternatively, different users may receive messages regarding changed in activity panel sets when those changes only pertain to them. For example, if the user 704 has no responsibility for plumbing work, or elects not to receive such messages, the user 704 may not receive related messages. Similarly, the user 704 may not elect to receive messages for activity panel changes made by the user 702 because the user 702 has different responsibilities that do not pertain to the user 704. Thus, messages may be passed or suppressed selectively based on an identified topic or content of the activity panels, the identity of the user making the change to the activity panels, or other user preferences.

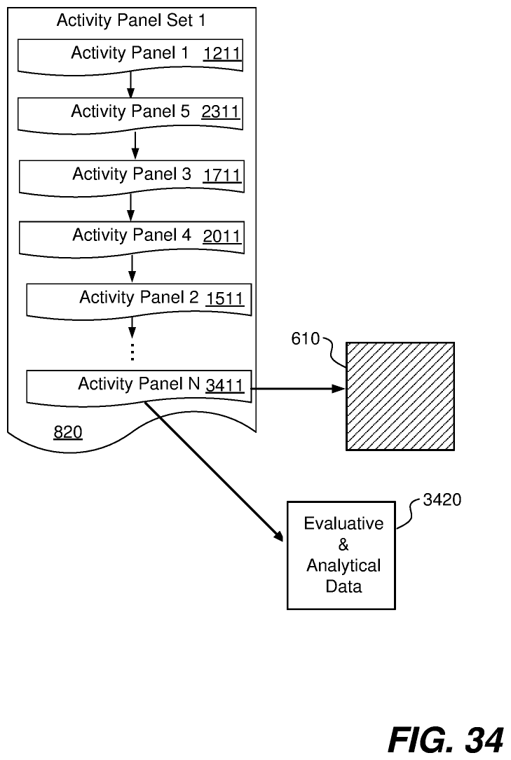

Referring to FIG. 34, activity panel N 3411 is associated with a photograph 610 or other media file indicating completion of a task or project. Activity panel N 3411 thus may include expressly provided evaluative and analytical data 3420 that describes when the work was completed and include comments (as well as the media file 610) describing the work. Implicitly, activity panel N 3411 also may provide information regarding how long the task or job required and how much work was performed by comparing activity panel N 3411 to activity panels associated with the original identification and description of the task or problem. By recording timestamped information about tasks and different events related to how the issues have been addressed, various embodiments provide a detailed record that may be used to evaluate the effectiveness and timeliness of responses to tasks logged by one or more activity panels.

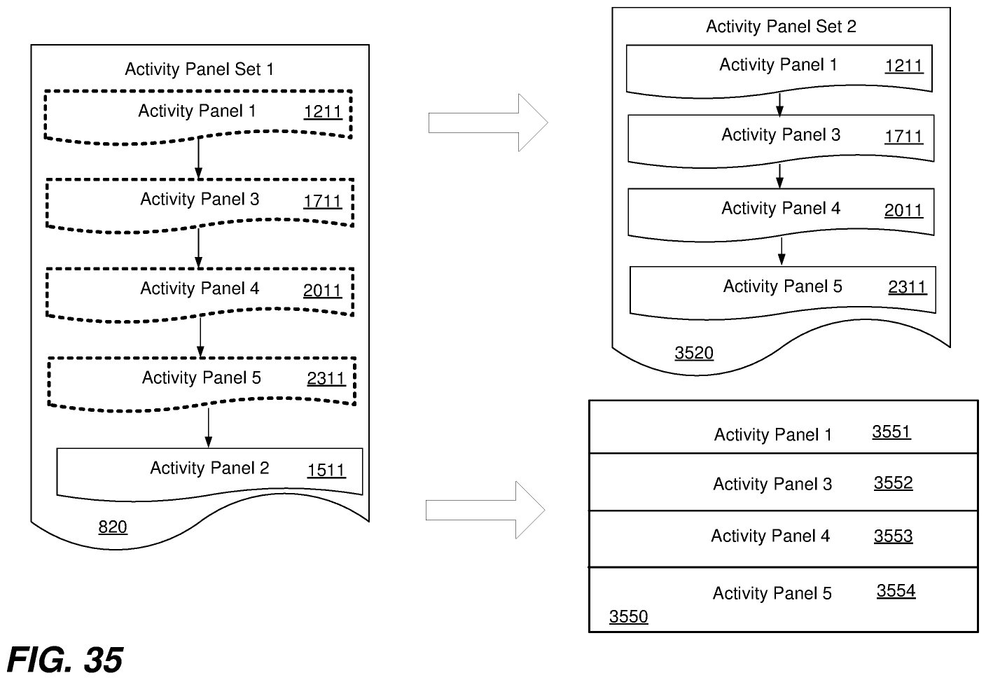

Referring additionally to FIG. 35, additional activity panel sets and reports may be generated by selecting activity panels from an existing activity panel set. For example, from activity panel set 1 820, a user may select all the activity panels that deal with plumbing issues but not the activity panel related to painting issues (as described with reference to FIGS. 11-34). The user may select desired activity panels by highlighting the activity panels of interest, including activity panel 1 1211, activity panel 3 1711, activity panel 4 2011, and activity panel 5 2311 (but not activity panel 2 1511). By selecting an option to generate a new activity panel set, the user may generate activity panel set 2 3520 that includes only the previously-selected activity panels. Newly-created activity panel set 2 3520 could be identified with individuals only involved in the plumbing issues (perhaps not to overwhelm uninvolved users with the plethora of plumbing issues at the site). Similarly, after selecting records, a report 3550 formatted for printing or, at least, page-style viewing may be generated. As previously described with reference to FIG. 3, the report 3550 may reformat the content of selected activity panels 1211, 1711, 2011, and 1511 into corresponding representations 3551, 3552, 3553, and 3554 sized and formatted for the size and shape of a printed page.

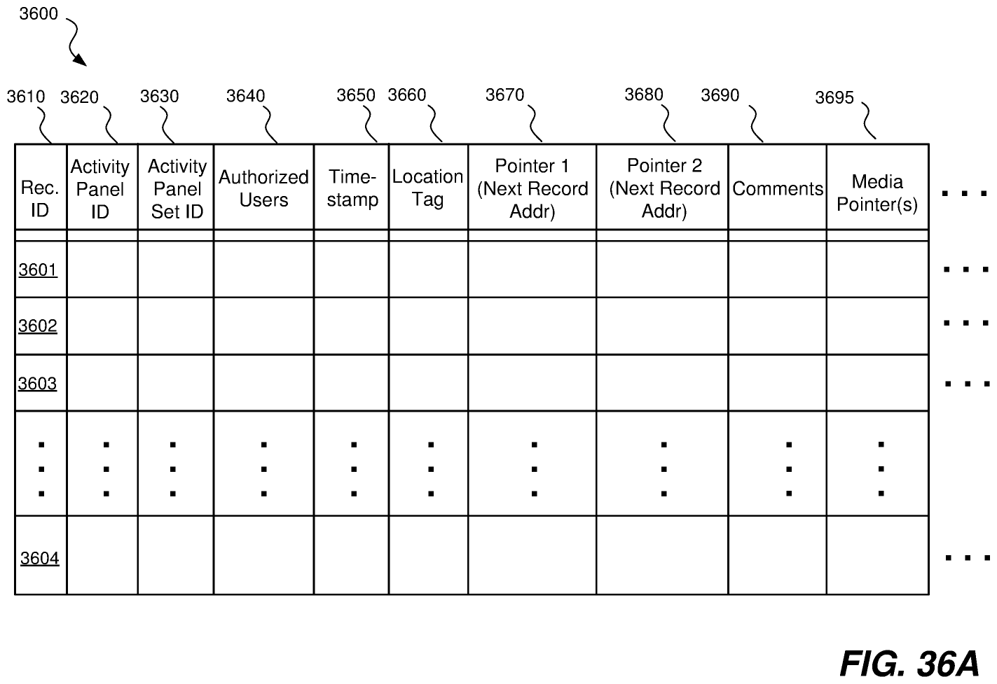

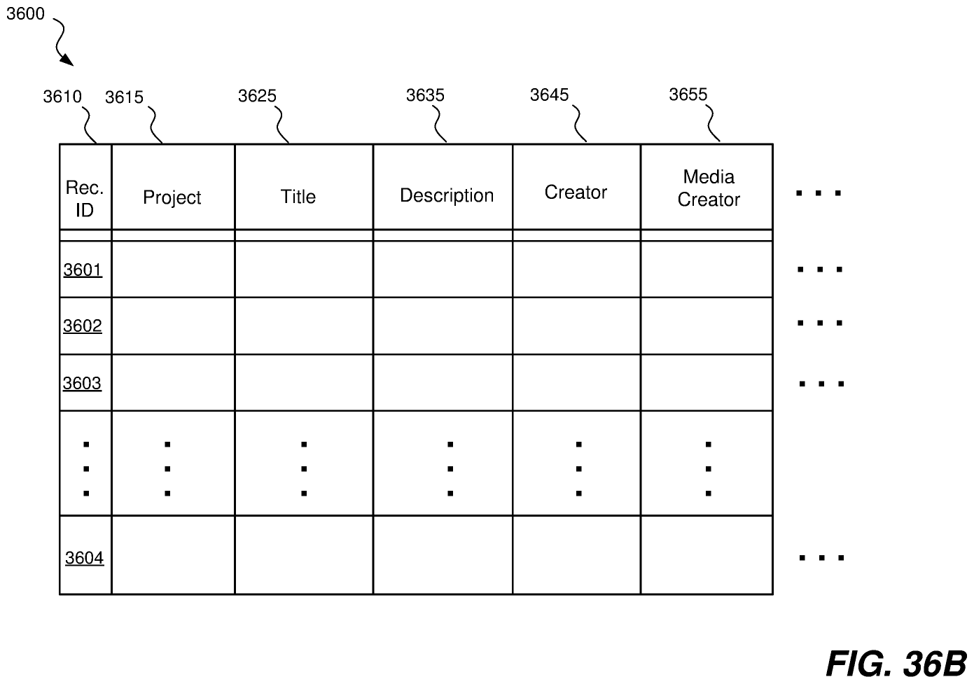

Referring additionally to FIGS. 36A and 36B, the content of the database that maintains all of the records for the activity panels may be maintained in an array-type data structure 3600. The array-type data structure 3600 includes fields for a record identifier 3610 (standard in database management software). Referring to FIG. 36A, the data structure 3600 also includes an activity panel identifier 3620 and an activity panel set identifier 3630 that are associated with all activity panels, as previously described. As also further described, in various embodiments the data structure 3600 also includes authorized users 3640, a timestamp of the activity panel's creation 3650, and a location tag 3660 from the location where the activity panel was created. As previously described, the location tag may include location data generated by the location circuitry, such as GPS circuitry and/or geolocation circuitry. Maintaining the timestamp 3650 provides for chronological tracking of activity panels. Further, in combination with the geolocation information provided in the location tag 3660, tracking of worker time on site allows for accurate tracking of workers' time. It will be appreciated that, with the time stamping of activity panels that a user may create or to which a user may respond, management may not only have information as to when personnel are on site, but what they are doing on site, and whether they are appropriately responding to outstanding issues represented in activity panels.

As also described at length, the data structure 3600 includes pointers 3670 (and if more than one is desired) and 3680. With the pointers 3670 and 3680 stored in the data structure 3600, an activity panel set can be generated with the activity panels in a desired order, regardless of the order in which the activity panels' records are actually stored. The data structure 3600 also may include fields for comments 3690 and other textual information stored in an activity panel as well as a pointer to media files 3695 that were associated with the activity panel. The media files may include photographs, sequences of photographs, videos, text documents, web pages or web site addresses, portable document format (PDF) files, sound recordings, and other digital files that incorporate information that is potentially relevant to the project, as previously described with reference to FIGS. 6A-60. Each of the rows 3601-3604 stores data for a record of an activity panel.

Referring to FIG. 36B, the data structure may include any number of additional fields. Fields may include narrative or creator information associable with any of the activity panels, such as a project name or identifier 3615, a title 3625 of the activity panel, and a description 3635 of the activity panel. Included in the data structure for each of the records representing an activity panel are the creator 3645 of the activity panel and a media creator 3655 for media (linked in by one or more pointers in field 3695) because the individual that creates an activity panel may not be the same person that created the document, chart, file, images, or other media to which the activity panel is linked. Any type of desired or relevant information may be associated with activity panels and, thus, stored in the data structure 3600.

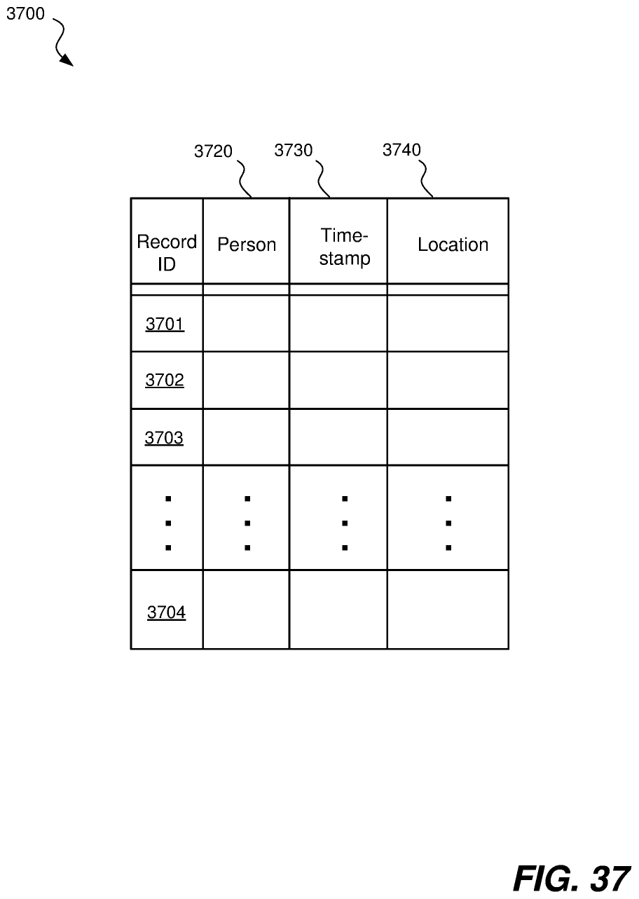

Referring additionally to FIG. 37, it will be appreciated that additional data structures may be used to capture data made available by various embodiments. For example, as previously described, with individuals carrying smartphones equipped with location circuitry 285 (FIG. 2) and the ability to specify a location of a job site, the location of the individuals may be tracked to log their time in or out at a job site or to apportion the individuals' time between sites. The time that an individual spends at any one job site may not be strictly relevant to the activity panels being created and stored as previously described. However, because the data is available, the data could be logged in a separate database or data structure.

Continuing to refer to FIG. 37, in various embodiments a data structure 3700 is a table that stores a record at each line 3701-3704 for each time received by the system for: a person 3720 who is recognized by the system; a timestamp 3730 that indicates that the person 3720 was within a geo-fence; and a recognized location 3740 of the geo-fence. By tabulating the timestamps 3730 and locations 3740 for each person 3720, it can be determined how long the person spent at each job site for the time period in question. The information can be used to generate or verify time reports, to assign or apportion costs for that person's time, and for other reasons. Thus, although there may not be a reason associated with the previously-described activity panels to continually monitor individuals' time in relation to the activity panels themselves, the information remains available and may be logged to a data structure.

Again, it will be appreciated that, although the foregoing example has been described using disclosed systems and methods for managing a construction or repair project, the disclosed embodiments are not limited to use in this context. Various embodiments may be employed in any situation where an aspect of a situation may be associated with an activity panel and it may be desired to insert a subsequently-created activity panel adjacent a selected pre-existing activity panel.

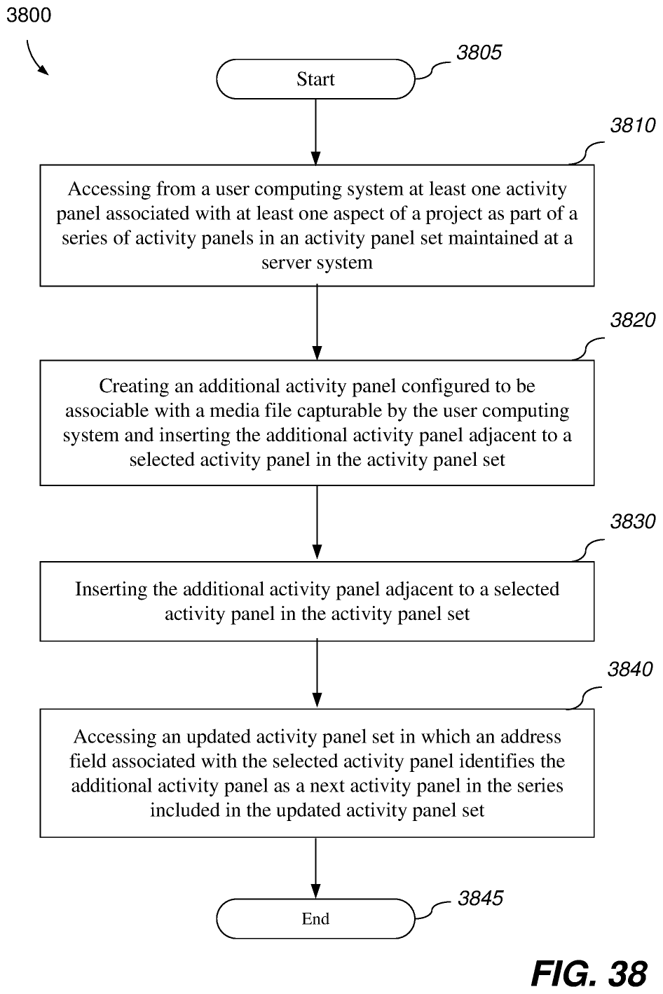

Referring additionally to FIG. 38, a flow diagram represents an illustrative method 3800 of a user computing system engaging with a server system to insert an additional activity panel at a selected location. The method 3800 starts at a block 3805. At a block 3810, from a user computing system, at least one activity panel associated with at least one aspect of a project as part of a series of activity panels in an activity panel set maintained at a server system is accessed. At a block 3820, an additional activity panel configured to be associable with a media file capturable by the user computing system is created. At a block 3830, the additional activity panel is inserted adjacent to a selected activity panel in the activity panel set. At a block 3840, an updated activity panel set in which an address field associated with the selected activity panel identifies the additional activity panel as a next activity panel in the series included in the updated activity panel set is accessed. The method 3800 ends at a block 3845.

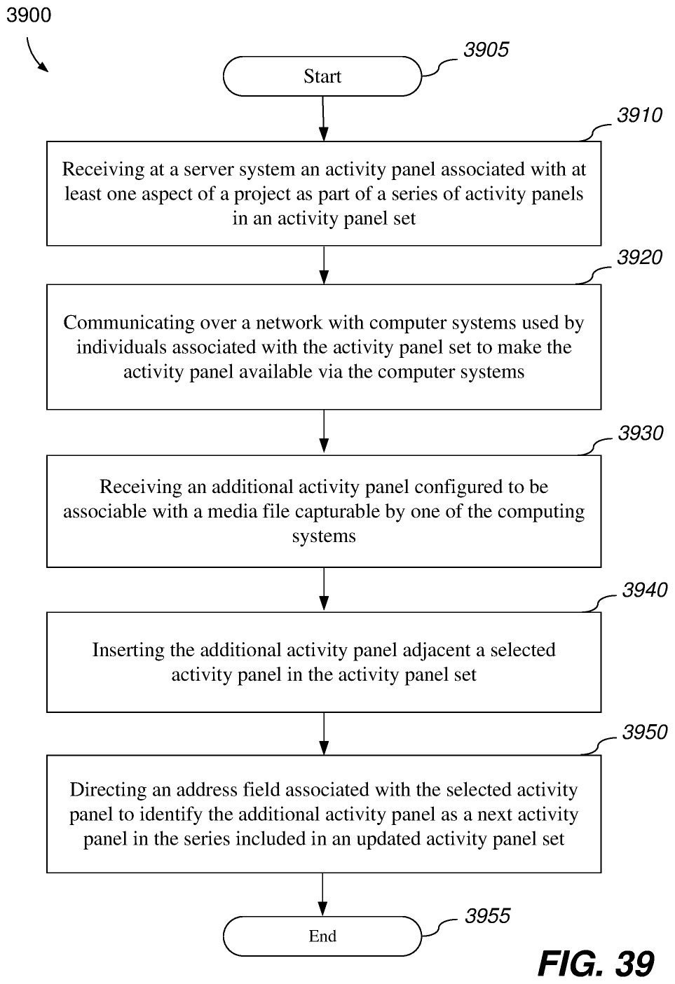

Referring to FIG. 39, a flow diagram represents an illustrative method 3900 of a server system responsive to a user computing system to insert an additional activity panel at a selected location. The method 3900 starts at a block 3905. At a block 3910, at a server system, an activity panel associated with at least one aspect of a project as part of a series of activity panels in an activity panel set is received. At a block 3920, the server system communicates over a network with computer systems used by individuals associated with the activity panel set to make the activity panel available via the computer systems. At a block 3930, an additional activity panel configured to be associable with a media file capturable by one of the computing systems is received. At a block 3940, the additional activity panel is inserted adjacent to a selected activity panel in the activity panel set. At a block 3950, an address field associated with the selected activity panel is directed to identify the additional activity panel as a next activity panel in the series included in an updated activity panel set. The method 3900 ends at a block 3955.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

It will be appreciated that the detailed description set forth above is merely illustrative in nature and variations that do not depart from the gist and/or spirit of the claimed subject matter are intended to be within the scope of the claims. Such variations are not to be regarded as a departure from the spirit and scope of the claimed subject matter.

What is claimed is:

1-9. (canceled)

10. A system comprising:
a server system configured to:
receive an activity panel associated with at least one aspect of a project as part of a series of activity panels in an activity panel set;
communicate with computer systems used by individuals associated with the activity panel set to make the activity panel available to the individuals using the computing systems;
receive an additional activity panel from one of the computing systems configured to be associable with a media file capturable by the computing system and insert the additional activity panel adjacent to a selected activity panel in the activity panel set; and
direct an address field associated with the selected activity panel to identify the additional activity panel as a next activity panel in the series included in an updated activity panel set.

11. The system of claim 10, wherein the server system is configured to manipulate pointers to be able to direct the address field associated with the selected activity panel to identify the additional activity panel as the next activity panel in the series included in the updated activity panel set.

12. The system of claim 10, wherein the server system is configured to receive the media file and associate the media file with the additional activity panel.

13. The system of claim 10, wherein the media file includes a file chosen from one of a digital image, a series of digital images captured in a sequence, a motion video, a text document, a graph, a chart, a spreadsheet, a digital document, a web page, a web site address, and an audio recording.

14. The system of claim 10, wherein the server system is configured to receive location data chosen from at least one of global positioning system (GPS) data and geolocation data related to the creation of the additional activity panel.

15. The system of claim 10, wherein the server system is configured to associate a location with a site related to the activity panel set to establish a geo-fence around the site to track when one of the computer systems used by the individuals associated with the activity panel set is present within the geo-fence around the site.

16. The system of claim 10, wherein the server system is configured to receive a selection of selected activity panels from the activity panel set for inclusion in a report and collect the selected activity panels in the report.

17. The system of claim 10, wherein the server system is configured to generate a message indicating availability of the updated activity panel set.

18-37. (canceled)

38. A computer-implemented method comprising:
receiving at a server system an activity panel associated with at least one aspect of a project as part of a series of activity panels in an activity panel set;
communicating over a network with computer systems used by individuals associated with the activity panel set to make the activity panel available via the computer systems;
receiving an additional activity panel configured to be associable with a media file capturable by one of the computing systems;
inserting the additional activity panel adjacent a selected activity panel in the activity panel set; and
directing an address field associated with the selected activity panel to identify the additional activity panel as a next activity panel in the series included in an updated activity panel set.

39. The computer-implemented method of claim 38, further comprising manipulating pointers for directing the address field associated with the selected activity panel to identify the additional activity panel as the next activity panel in the series included in the updated activity panel set.

40. The computer-implemented method of claim 38, further comprising receiving the media file and associating the media file with the additional activity panel.

41. The computer-implemented method of claim 38, wherein the media file includes a file chosen from one of a digital image, a series of digital images captured in a sequence, a motion video, a text document, a graph, a chart, a spreadsheet, a digital document, a web page, a web site address, and an audio recording.

42. The computer-implemented method of claim 38, further comprising receiving location data related to the creation of the additional activity panel, the location data including at least one set of data chosen from global positioning system (GPS) data and geolocation data.

43. The computer-implemented method of claim 38, further comprising associating a location with a site related to the activity panel set to establish a geo-fence around the site to track when one of the computer systems is present within the geo-fence around the site.

44. The computer-implemented method of claim 38, further comprising enabling user selection of selected activity panels from the activity panel set for inclusion in a report.

45. The computer-implemented method of claim 38, further comprising generating a message indicating availability of the updated activity panel set.

46-54. (canceled)

55. A non-transitory computer-readable medium storing therein computer-executable instructions to cause a server computing system to:
receive an activity panel associated with at least one aspect of a project as part of a series of activity panels in an activity panel set;
communicate over a network with computer systems used by individuals associated with the activity panel set to make the activity panel available via the computer systems;
receive an additional activity panel configured to be associable with a media file capturable by one of the computing systems;
insert the additional activity panel adjacent a selected activity panel in the activity panel set; and
direct an address field associated with the selected activity panel to identify the additional activity panel as a next activity panel in the series included in an updated activity panel set.

56. The non-transitory computer-readable medium of claim 55, further comprising computer-executable instructions to cause the server computing system to direct the address field associated with the selected activity panel to identify the additional activity panel as the next activity panel in the series included in the updated activity panel set.

57. The non-transitory computer-readable medium of claim 55, further comprising computer-executable instructions to cause the server computing system to receive the media file and associating the media file with the additional activity panel.

58. The non-transitory computer-readable medium of claim 55, wherein
the media file includes a file chosen from one of a digital image, a series of digital images captured in a sequence, a motion video, a text document, a graph, a chart, a spreadsheet, a digital document, a web page, a web site address, and an audio recording.

59. The non-transitory computer-readable medium of claim 55, further comprising computer-executable instructions to cause the server computing system to receive location data related to the creation of the additional activity panel, the location data including at least one set of data chosen from global positioning system (GPS) data and geolocation data.

60. The non-transitory computer-readable medium of claim 59, further comprising computer-executable instructions to cause the server computing system to associate a location with a site related to the activity panel set to establish a geo-fence around the site to track when one of the computer systems is present within the geo-fence around the site.

61. The non-transitory computer-readable medium of claim 55, further comprising computer-executable instructions to cause the server computing system to enable user selection of selected activity panels from the activity panel set for inclusion in a report.

62. The non-transitory computer-readable medium of claim 55, further comprising computer-executable instructions to cause the server computing system to generate a message indicating availability of the updated activity panel set.
